(19) United States
(12) Patent Application Publication
(10) Pub. No.: US 2022/0061117 A1
(43) Pub. Date: Feb. 24, 2022

(54) METHOD OF UPDATING SPATIAL PARAMETERS AND RELATED DEVICE

(71) Applicant: FG Innovation Company Limited, Tuen Mun (HK)

(72) Inventors: JIA-HONG LIOU, Taipei (TW); CHIA-HAO YU, Taipei (TW)

(21) Appl. No.: 17/408,833

(22) Filed: Aug. 23, 2021

Related U.S. Application Data
(60) Provisional application No. 63/068,967, filed on Aug. 21, 2020.

(51) Int. Cl. H04W 76/19; H04W 72/04; H04L 5/00

(52) U.S. Cl. CPC H04W 76/19; H04L 5/0048; H04W 72/042; H04W 72/0413

(57) ABSTRACT

A method of updating spatial parameters for a UE is provided. The method includes receiving, from a network, at least one configuration for one or more serving cells; receiving, from the network, a BFR configuration applicable for a serving cell of the one or more serving cells; detecting a beam failure in the serving cell of the one or more serving cells; transmitting, to the network, a request for a BFR in the serving cell, the request indicating a DL RS or being associated with the DL RS; receiving, from the network, a response corresponding to the transmitted request; receiving, after receiving the response, one or more CORESETs in the serving cell via a spatial RX parameter derived from the DL RS; and transmitting, after receiving the response, one or more PUCCH resources in the serving cell via a spatial TX parameter derived from the DL RS.

### CROSS-REFERENCE TO RELATED APPLICATION(S)

The present disclosure claims the benefit of and priority to U.S. Provisional Patent Application Ser. No. 63/068,967 filed on Aug. 21, 2020, entitled “METHOD AND APPARATUS FOR UPDATING BEAMS AND PARAMETERS IN A WIRELESS COMMUNICATION SYSTEM,” (hereinafter referred to as “the '967 provisional”). The disclosure of the '967 provisional is hereby incorporated fully by reference into the present disclosure.

### FIELD

The present disclosure is generally related to wireless communications and more specifically, to a method of updating beams and a related device.

### BACKGROUND

With the tremendous growth in the number of connected devices and the rapid increase in user/network traffic volume, various efforts have been made to improve different aspects of wireless communication for the next-generation wireless communication system, such as the fifth-generation (5G) New Radio (NR), by improving data rate, latency, reliability, and mobility.

The 5G NR system is designed to provide flexibility and configurability for optimizing the network services and types and accommodating various use cases such as enhanced Mobile Broadband (eMBB), massive Machine-Type Communication (mMTC), and Ultra-Reliable and Low-Latency Communication (URLLC).

However, as the demand for radio access continues to increase, there is a need for further improvements in wireless communication for the next-generation wireless communication system.

### SUMMARY

The present disclosure provides a method of updating spatial parameters and a related device.

According to an aspect of the present disclosure, a method of updating spatial parameters for a user equipment (UE) is provided. The method includes receiving, from a network, at least one configuration for one or more serving cells; receiving, from the network, a beam failure recovery (BFR) configuration applicable for a serving cell of the one or more serving cells; detecting a beam failure in the serving cell of the one or more serving cells; transmitting, to the network, a request for a BFR in the serving cell, the request indicating a downlink (DL) reference signal (RS) or being associated with the DL RS; receiving, from the network, a response corresponding to the transmitted request; receiving, after receiving the response, one or more control resource sets (CORESETs) in the serving cell via a spatial receiving (RX) parameter derived from the DL RS; and transmitting, after receiving the response, one or more physical uplink control channel (PUCCH) resources in the serving cell via a spatial transmitting (TX) parameter derived from the DL RS.

According to another aspect of the present disclosure, a UE for performing updating spatial parameters is provided. The UE includes a processor configured to execute a computer-executable program, and a memory coupled to the processor and configured to store the computer-executable program, wherein the computer-executable program instructs the processor to perform the above-described method of updating spatial parameters.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart illustrating a method of updating spatial parameters, according to an implementation of the present disclosure.

FIG. 2 is a schematic diagram illustrating a transmitter block diagram for Cyclic prefix (CP) Orthogonal Frequency Division Multiplexing (OFDM) with optional discrete Fourier transform (DFT) spreading, according to an implementation of the present disclosure.

FIG. 3 is a schematic diagram illustrating an UL-DL timing relation, according to an implementation of the present disclosure.

FIG. 4 is a schematic diagram illustrating a time-frequency structure of Synchronization Signal and Physical Broadcast Channel (PBCH) Block (SSB), according to an implementation of the present disclosure.

FIG. 5 is a schematic diagram illustrating a Transmission Configuration Indicator (TCI) states activation/deactivation, according to an implementation of the present disclosure.

FIG. 6 is a schematic diagram illustrating a TCI state indication, according to an implementation of the present disclosure.

FIG. 7 is a schematic diagram illustrating a physical uplink control channel (PUCCH) spatial relation activation/deactivation Medium Access Control (MAC) control element (CE), according to an implementation of the present disclosure.

FIG. 8A is a schematic diagram illustrating a Secondary Cell (SCell) Beam Failure Recovery (BFR) and a truncated SCell BFR MAC CE, according to an implementation of the present disclosure.

FIG. 8B is a schematic diagram illustrating a Secondary Cell (SCell) Beam Failure Recovery (BFR) and a truncated SCell BFR MAC CE, according to another implementation of the present disclosure.

FIG. 9 is a schematic diagram illustrating an enhanced PUCCH spatial relation activation/deactivation MAC CE, according to an implementation of the present disclosure.

FIG. 10 is a schematic diagram illustrating an overview of UE Radio Resource Control (RRC) state machine and state transitions, according to an implementation of the present disclosure.

FIG. 11 is a schematic diagram illustrating an overview of UE state machine and state transitions in New Radio (NR) as well as the mobility procedures supported between NR/5G Core (5GC), Evolved Universal Terrestrial Radio Access (E-UTRA)/Evolved Packet Core (EPC) and E-UTRA/5GC, according to an implementation of the present disclosure.

FIG. 12 is a block diagram illustrating a node for wireless communication, according to an implementation of the present disclosure.

### DESCRIPTION

The following disclosure contains specific information pertaining to exemplary implementations in the present disclosure. The drawings and their accompanying detailed disclosure are directed to exemplary implementations. However, the present disclosure is not limited to these exemplary implementations. Other variations and implementations of the present disclosure will occur to those skilled in the art. Unless noted otherwise, like or corresponding elements in the drawings may be indicated by like or corresponding reference numerals. Moreover, the drawings and illustrations are generally not to scale and are not intended to correspond to actual relative dimensions.

For consistency and ease of understanding, like features are identified (although, in some examples, not shown) by reference designators in the exemplary drawings. However, the features in different implementations may be different in other respects, and therefore shall not be narrowly confined to what is shown in the drawings.

The phrases “in one implementation,” and “in some implementations,” may each refer to one or more of the same or different implementations. The term “coupled” is defined as connected, whether directly or indirectly via intervening components, and is not necessarily limited to physical connections. The term “comprising” may mean “including, but not necessarily limited to” and specifically indicate open-ended inclusion or membership in the disclosed combination, group, series, and equivalents.

The term “and/or” herein is only an association relationship for describing associated objects and represents that three relationships may exist, for example, A and/or B may represent that: A exists alone, A and B exist at the same time, and B exists alone. “A and/or B and/or C” may represent that at least one of A, B, and C exists, A and B exist at the same time, A and C exist at the same time, B and C exist at the same time, and A, B and C exist at the same time. Besides, the character “/” used herein generally represents that the former and latter associated objects are in an “or” relationship.

Additionally, any two or more of the following paragraphs, (sub)-bullets, points, actions, behaviors, terms, alternatives, examples, or claims in the present disclosure may be combined logically, reasonably, and properly to form a specific method. Any sentence, paragraph, (sub)-bullet, point, action, behavior, term, or claim in the present disclosure may be implemented independently and separately to form a specific method. Dependency, e.g., “based on”, “more specifically”, “preferably”, “In one embodiment”, “In one implementation”, “In one alternative”, in the present disclosure may refer to just one possible example that would not restrict the specific method.

For a non-limiting explanation, specific details, such as functional entities, techniques, protocols, standards, and the like, are set forth for providing an understanding of the disclosed technology. In other examples, detailed disclosure of well-known methods, technologies, systems, and architectures are omitted so as not to obscure the present disclosure with unnecessary details.

Persons skilled in the art will recognize that any disclosed network function(s) or algorithm(s) may be implemented by hardware, software, or a combination of software and hardware. Disclosed functions may correspond to modules that may be software, hardware, firmware, or any combination thereof. The software implementation may comprise computer-executable instructions stored on a computer-readable medium, such as memory or other types of storage devices. For example, one or more microprocessors or general-purpose computers with communication processing capability may be programmed with corresponding executable instructions and carry out the disclosed network function(s) or algorithm(s). The microprocessors or general-purpose computers may be formed of Application-Specific Integrated Circuits (ASICs), programmable logic arrays, and/or using one or more Digital Signal Processors (DSPs). Although some of the disclosed implementations are directed to software installed and executing on computer hardware, nevertheless, alternative implementations as firmware or as hardware or combination of hardware and software are well within the scope of the present disclosure.

The computer-readable medium may include, but may not be limited to, Random Access Memory (RAM), Read-Only Memory (ROM), Erasable Programmable Read-Only Memory (EPROM), Electrically Erasable Programmable Read-Only Memory (EEPROM), flash memory, Compact Disc (CD) Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, or a New Radio (NR) system) may typically include at least one base station (BS), at least one UE, and one or more optional network elements that provide connection with a network. The UE may communicate with the network (e.g., a Core Network (CN), an Evolved Packet Core (EPC) network, an Evolved Universal Terrestrial Radio Access Network (E-UTRAN), a Next-Generation Core (NGC), a 5G Core (5GC), or an internet) via a Radio Access Network (RAN) established by one or more BSs.

A UE according to the present disclosure may include, but is not limited to, a mobile station, a mobile terminal or device, or a user communication radio terminal. For example, a UE may be a portable radio equipment that includes, but is not limited to, a mobile phone, a tablet, a wearable device, a sensor, or a Personal Digital Assistant (PDA) with wireless communication capability. The UE may be configured to receive and transmit signals over an air interface to one or more cells in a RAN.

A BS may include, but is not limited to, a node B (NB) as in the Universal Mobile Telecommunication System (UMTS), an evolved node B (eNB) as in the LTE-A, a Radio Network Controller (RNC) as in the UMTS, a Base Station Controller (BSC) as in the Global System for Mobile communications (GSM)/GSM Enhanced Data rates for GSM Evolution (EDGE) RAN (GERAN), a next-generation eNB (ng-eNB) as in an Evolved Universal Terrestrial Radio Access (E-UTRA) BS in connection with the 5GC, a next-generation Node B (gNB) as in the 5G-RAN (or in the 5G Access Network (5G-AN)), and any other apparatus capable of controlling radio communication and managing radio resources within a cell. The BS may connect to serve the one or more UEs via a radio interface to the network.

A BS may be configured to provide communication services according to at least one of the following Radio Access Technologies (RATs): Worldwide Interoperability for Microwave Access (WiMAX), GSM (often referred to as 2G), GERAN, General Packet Radio Service (GRPS), UMTS (often referred to as 3G) according to basic Wideband-Code Division Multiple Access (W-CDMA), High-Speed Packet Access (HSPA), LTE, LTE-A, enhanced LTE (eLTE), NR (often referred to as 5G), and/or LTE-A Pro. However, the scope of the present disclosure is not limited to these protocols.

The BS may be operable to provide radio coverage to a specific geographical area using a plurality of cells forming the RAN. The BS may support the operations of the cells. Each cell may be operable to provide services to at least one UE within its radio coverage. More specifically, each cell (often referred to as a serving cell) may provide services to one or more UEs within its radio coverage (e.g., each cell schedules the downlink (DL) and optionally UL resources to at least one UE within its radio coverage for DL and optionally UL packet transmissions). The BS may communicate with one or more UEs in the radio communication system via the plurality of cells.

A cell may allocate Sidelink (SL) resources for supporting Proximity Service (ProSe), LTE SL services, and LTE/NR Vehicle-to-Everything (V2X) services. Each cell may have overlapped coverage areas with other cells. In Multi-RAT Dual Connectivity (MR-DC) cases, the primary cell of a Master Cell Group (MCG) or a Secondary Cell Group (SCG) may be called as a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), comprising the SpCell and optionally one or more Secondary Cells (SCells). An SCG may refer to a group of serving cells associated with the Secondary Node (SN), comprising the SpCell and optionally one or more SCells.

As disclosed previously, the frame structure for NR is to support flexible configurations for accommodating various next-generation (e.g., 5G) communication requirements, such as eMBB, mMTC, and URLLC, while fulfilling high reliability, high data rate, and low latency requirements. The orthogonal frequency-division multiplexing (OFDM) technology, as agreed in the 3rd Generation Partnership Project (3GPP), may serve as a baseline for an NR waveform. The scalable OFDM numerology, such as the adaptive sub-carrier spacing, the channel bandwidth, and the cyclic prefix (CP), may also be used. Additionally, two coding schemes are applied for NR: (1) low-density parity-check (LDPC) code and (2) polar code. The coding scheme adaption may be configured based on the channel conditions and/or the service applications.

Moreover, in a transmission time interval of a single NR frame, at least DL transmission data, a guard period, and UL transmission data should be included. The respective portions of the DL transmission data, the guard period, and the UL transmission data should also be configurable, for example, based on the network dynamics of NR. An SL resource may also be provided via an NR frame to support ProSe services or V2X services.

5G/NR has been developed over the past several years. For NR, especially Frequency Range 2 (FR2), beamforming technology has been recognized an important method for conquering high power penetration. Hence, the beam management and beam failure recovery procedure has hardly been developed. Starting from the 3GPP Rel-15/16, a Beam Failure Recovery (BFR) procedure may include beam failure detection (BFD), beam failure recovery request transmission, and beam failure recovery response reception. Upon successful beam failure recovery, the UE may update control beams automatically.

However, such beam update is only performed in one serving cell. It is a typical case that more than one serving cell share the same DL or UL beams. The Network may need to update beams of other serving cells via at least one signaling transmission, which may cause much signaling overhead. Therefore, it is seen as beneficial to provide a procedure to update beams of multiple serving cells at the same time. Meanwhile, which serving cells can be updated at the same time must also be given careful consideration. The term “beam” may be referred to or replaced with “spatial RX parameter” or “spatial TX parameter.”

To solve at least the above-mentioned issues, a method of updating DL/UL beams is disclosed.

Some or all of the following terminology and assumption may be used hereafter.

BS: A network central unit or a network node in NR, which is used to control one or multiple Transmission/Reception Points (TRPs) that are associated with one or multiple cells. Communication between a BS and TRP(s) is via fronthaul. The BS may be referred to as a central unit (CU), an eNB, a gNB, or a NodeB.

TRP: A transmission and reception point provides network coverage and directly communicates with UEs. The term “TRP” may be referred to as a “distributed unit (DU)” or a “network node.”

Cell: A cell is composed of one or multiple associated TRPs (e.g., coverage of the cell is composed of coverage of all associated TRP(s)). One cell controlled by one BS. Cell may be referred to as a TRP group (TRPG).

Serving beam: A Serving beam for a UE is a beam generated by a network node (e.g., TRP) that is configured to communicate with the UE (e.g., for transmission and/or reception).

Candidate beam: A Candidate beam for a UE is a candidate of a serving beam. A Serving beam may or may not be candidate beam.

In the present disclosure, the terms “Quasi Co-Location (QCL) assumption” or “Transmission Configuration Indicator (TCI) state” may be referred to or replaced with at least one of the following: “a DL TCI or DL TCI associated with a QCL type-D, DL beam,” “a Spatial transmission filter,” “Spatial (RX) parameters,” “a Spatial relationship” or “a Spatial assumption.”

In the present disclosure, the term “spatial relation for transmitting a UL resource (e.g., Physical Uplink Control Channel (PUCCH))” may be referred to or replaced with at least one of the following: “a UL beam,” “a UL TCI,” “a Spatial transmission filter,” a “Transmission precoder,” “Spatial (TX) parameters” or “a Spatial relationship.”

A panel may mean an antenna (port) group or an antenna (port) set. There may be more than one DL/UL beam associated with one panel. When one transmitting node (UE or NW) is performing a transmission via a panel, only one beam associated with the panel could be used to perform the transmission. For a transmitter including more than one panel (e.g., two panels), two beams associated with the two panels respectively are used to perform a transmission.

A TRP identifier may mean or be referred to as “a (candidate) value of a TRP identifier.” For example, the first TRP identifier is a first candidate value of a TRP identifier or a first TRP identifier value, and the second TRP identifier is a second candidate value of a TRP identifier or a second TRP identifier value.

A panel identifier may mean or be referred to as “a (candidate) value of a panel identifier.” For example, the first panel identifier is a first candidate value of a panel identifier or a first panel identifier value, and the second panel identifier is a second candidate value of a panel identifier or a second panel identifier value.

When a procedure is related to a serving cell, the procedure may be related to an active (DL/UL) bandwidth part (BWP) in the serving cell.

UE configurations in the present disclosure are disclosed.

In some implementations, the UE may be configured with and/or served in a serving cell by a network. In some implementations, the UE may be configured with one or more serving cells, which may include the serving cell. In some implementations, the UE may be activated or be indicated to activate one or more serving cells, which may include the serving cell.

In some implementations, the UE may be configured for and/or indicate one or more BWP. In some implementations, the UE may indicate and/or configured for a BWP (in the serving cell). Preferably, the previously mentioned BWP may be activated as or replaced with an active BWP, an active DL BWP, an active UL BWP, an initial BWP, a default BWP, or a dormant BWP.

In some implementations, the UE may perform DL reception from and/or UL transmission to a first TRP. In some implementations, the UE may perform DL reception from and/or UL transmission to a second TRP. Preferably, the first TRP may be located in the serving cell. Preferably, the second TRP may be located in the serving cell, or in a neighboring cell.

In some implementations, the UE may include or be equipped with one or more panels. Some or all of the one or more panels may be used or activated for DL reception (performed at the same time or same time interval). Some or all of the one or more panels may be used or activated for UL transmission (performed at the same time or same time interval).

In some implementations, the UE may be in RRC_CONNECTED state, RRC_INACTIVE state or RRC_IDLE state.

In some implementations, the UE may be configured with or indicated (or may derive) one or more TRP identifier(s). A TRP identifier may be associated with a TRP. Preferably, a DL transmission associated with a TRP identifier may mean that the DL transmission may be transmitted form a TRP associated with the TRP identifier. Preferably, a UL transmission associated with a TRP identifier may mean that the UL transmission may be transmitted to a TRP associated with the TRP identifier. Preferably, a TRP identifier may be associated with a CORESETPoolIndex, or a value (candidate) of a CORESETPoolIndex.

In some implementations, the UE may be configured with or indicated (or may derive) one or more panel identifier(s).

Preferably, a panel identifier may be associated with a panel.

Preferably, a DL transmission associated with a panel identifier may mean that the DL transmission may be received by a panel associated with the panel identifier.

Preferably, a UL transmission associated with a panel identifier may mean that the UL transmission is transmitted by a panel associated with the panel identifier.

Preferably, a panel identifier may be associated with a Sounding Reference Signal (SRS) resource set index, or a value (candidate) of a SRS resource set index.

In some implementations, the UE may be configured with or indicated (or may derive) a first TRP identifier.

In some implementations, the UE may be configured with or indicated (or may derive) a second TRP identifier.

In some implementations, the UE may be configured with or indicated (or may derive) a first panel identifier.

In some implementations, the UE may be configured with or indicated (or may derive) a second panel identifier.

In some implementations, the UE may be configured with a PUCCH configuration (e.g., PUCCH-Config) in the BWP.

In some implementations, the UE may be configured with one or more PUCCH resources, where the one or more PUCCH resource are configured in the PUCCH configuration.

In some implementations, the UE may be configured with one or more PUCCH group(s).

In some examples, each of the one or more PUCCH group(s) may include some of the one or more PUCCH resources.

Preferably, spatial relations of PUCCH resources in a PUCCH group may be indicated and/or updated by a same MAC-CE.

Preferably, a PUCCH group or PUCCH resource(s) in a PUCCH group may be associated with a TRP identifier.

Preferably, a PUCCH group or PUCCH resource(s) in a PUCCH group may be associated with a (same) TRP.

Preferably, a PUCCH group or PUCCH resource(s) in a PUCCH group may be transmitted to a (same) TRP.

Preferably, a spatial relation or a PUCCH group or PUCCH resource(s) in a PUCCH group may be associated with a panel identifier.

Preferably, a spatial relation or a PUCCH group or PUCCH resource(s) in a PUCCH group may be associated with a (same) panel.

Preferably, a spatial relation or a PUCCH group or PUCCH resource(s) in a PUCCH group may be transmitted using a (same) panel.

Preferably, all the one or more PUCCH resources in the PUCCH configuration may be configured with a (respective) spatial relation.

Preferably, PUCCH-SpatialRelationInfo may be configured in the PUCCH configuration.

Preferably, some of the one or more PUCCH resources in the PUCCH configuration may be configured with a (respective) spatial relation, and others are not.

Alternatively (or additionally), PUCCH-SpatialRelationInfo may not be configured in the PUCCH configuration.

Alternatively (or additionally), none of the one or more PUCCH resources in the PUCCH configuration may be configured with a (respective) spatial relation.

In some implementations, the UE may be configured or served in a first BWP in a first serving cell by a network. The UE may be configured or served in a second BWP in a second serving cell by the network.

In some implementations, the UE may be configured with a BFR configuration. The BFR configuration may be configured in the BWP. The UE may be configured with at least one list. For example, the UE may be configured with a first list. The UE may be configured with a second list. The UE may be configured with a third list. The UE may be configured with a fourth list.

The first list (e.g., simultaneousTCI-UpdateList1-r16) may be associated with or include one or more serving cell (index).

The second list (e.g., simultaneousTCI-UpdateList2-r16) may be associated with or include one or more serving cell (index).

The third list (e.g., simultaneousSpatial-UpdatedList1-r16 may be associated with or include one or more serving cell (index).

The fourth list (e.g., simultaneousSpatial-UpdatedList2-r16) may be associated with or include one or more serving cell (index).

The UE may trigger a BFR procedure for the first serving cell, in response to detecting beam failure in the first serving cell. The BFR procedure may be a Random Access (RA) procedure triggered for the BFR procedure.

The UE may send or transmit a request or report to the network. The request or report may be used to inform that beam failure occurs in the first serving cell. The request or report may be a beam failure recovery request (BFRQ). The request or report may indicate information of a Reference Signal (RS) or a Synchronization Signal and Physical Broadcast Channel (PBCH) Block (SSB) (e.g., index). The request or report may be transmitted via a spatial relation. The spatial relation may be associated with or derived from a QCL assumption or TCI state for receiving the RS. The QCL assumption or TCI state is for performing a Physical Random Access Channel (PRACH) transmission for the BFR procedure. The spatial relation may be used for performing the PRACH transmission for the BFR procedure.

The UE may receive a response to the request or report (subsequently). The response may be a beam failure recovery response (BFRR). The BFR procedure is terminated or recognized as successful when or after the UE receives the response.

The previously mentioned QCL assumption or the TCI state may be associated with or include a QCL type-D.

I. DL Beam (or Spatial RX Parameter) Update for One or More Serving Cells after Successful BFR

In some implementations, when or after the UE receives the response, the UE may perform at least one of the following actions:

Action 1: Receive one or more Physical Downlink Control Channels (PDCCHs) in the first serving cell via the QCL assumption or TCI state;

Action 2: Receive one or more control resource sets (CORESETs) in the first serving cell via the QCL assumption or TCI state;

Action 3: Receive all CORESETs in the first serving cell via the QCL assumption or TCI state;

Action 4: Receive all CORESETs in the first serving cell via the QCL assumption or TCI state, excluding CORESET #0; and

Action 5: Receive one or more DL transmission(s) in the first serving cell via the QCL assumption or TCI state. The one or more DL transmission(s) may correspond to one or more physical downlink shared channels (PDSCHs).

In some implementations, when or after the UE receives the response, the UE may perform at least one of the following actions:

Action 1: Receive one or more PDCCHs in the second serving cell via the QCL assumption or TCI state;

Action 2: Receive one or more CORESETs in the second serving cell via the QCL assumption or TCI state;

Action 3: Receive all CORESETs in the second serving cell via the QCL assumption or TCI state;

Action 4: Receive all CORESETs in the second serving cell via the QCL assumption or TCI state, excluding CORESET #0; and

Action 5: Receive one or more DL transmission(s) in the second serving cell via the QCL assumption or TCI state

In some implementations, when or after the UE receives the response, and if the second serving cell and the first serving cell are included in or associated with a same list (e.g., the first list or the second list), the UE may perform at least one of the following actions:

Action 1: Receive one or more PDCCHs in the second serving cell via the QCL assumption or TCI state;

Action 2: Receive one or more CORESETs in the second serving cell via the QCL assumption or TCI state;

Action 3: Receive all CORESETs in the second serving cell via the QCL assumption or TCI state;

Action 4: Receive all CORESETs in the second serving cell via the QCL assumption or TCI state, excluding CORESET #0; and

Action 5: Receive one or more DL transmission(s) in the second serving cell via the QCL assumption or TCI state.

In some implementations, when or after the UE receives the response, the UE may perform at least one of the following actions:

Action 1: Receive one or more PDCCHs in other serving cell(s) via the QCL assumption or TCI state, where the said other serving cell(s) are included in a same list as the first serving cell (e.g., the first list or the second list);

Action 2: Receive one or more CORESET(s) in other serving cell(s) via the QCL assumption or TCI state, where the said other serving cell(s) are included in a same list as the first serving cell (e.g., the first list or the second list);

Action 3: Receive all CORESETs in other serving cell(s) via the QCL assumption or TCI state, where the said other serving cell(s) are included in a same list as the first serving cell (e.g., the first list or the second list);

Action 4: Receive all CORESETs in other serving cell(s) via the QCL assumption or TCI state, excluding CORESET #0, where the said other serving cell(s) are included in a same list as the first serving cell (e.g., the first list or the second list); and

Action 5: Receive one or more DL transmission(s) in other serving cell(s) via the QCL assumption or TCI state, where the said other serving cell(s) are included in a same list as the first serving cell (e.g., the first list or the second list)

The previously mentioned one or more DL transmission(s) may include one or more PDSCH resource(s). The previously mentioned one or more DL transmission(s) may include one or more Channel State Information based Reference Signal (CSI-RS) resource(s). The previously mentioned one or more DL transmission(s) may include one or more DL Positioning Reference Signal (PRS) resource(s).

For the implementations mentioned above, the UE may apply the QCL assumption or TCI state only when the first serving cell is a Primary Cell (PCell) or Primary Secondary Cell (PSCell).

For the implementations mentioned above, the UE may apply the QCL assumption or TCI state only when the first serving cell is a Secondary Cell (SCell).

For the implementations mentioned above, the UE may apply the QCL assumption or TCI state only when the first serving cell is a PCell or PSCell, and the second serving cell is a SCell.

For the implementations mentioned above, the UE may apply the QCL assumption or TCI state only when the first serving cell is a SCell, and the second serving cell is a SCell.

Moreover, for the implementations mentioned above, the UE may apply the QCL assumption or TCI state until the UE receives a first signal.

The first signal may be used to (explicitly) indicate or configure another QCL assumption or TCI state for receiving a PDCCH(s), or a CORESET(s) in the second serving cell. Alternatively or additionally, the first signal may be used to (explicitly) indicate or configure another QCL assumption or TCI state for receiving a PDCCH(s), or a CORESET(s) in the first serving cell.

The another QCL assumption or TCI state may be the same as or different from the QCL assumption or TCI state.

Furthermore, for the implementations mentioned above, the UE may apply the QCL assumption or TCI state when at least one of the following conditions is satisfied:

Condition 1: The first serving cell and the second serving cell both are associated with or operated with (only) one TRP.

At least for condition 1, a serving cell being associated with or operated with (only) one TRP may mean that an index is not configured for some or all CORESET(s) in the serving cell, where the index may be related to a TRP (e.g., CORESETPoolIndex).

At least for condition 1, a serving cell being associated with or operated with (only) one TRP may mean that the value of an index, configured for or associated with some or all CORESET(s) in the serving cell, is restricted to a specific value (e.g., 0). In other words, none of CORESET(s) is configured with the value of the index set as 1. The index may be related to a TRP (e.g., CORESETPoolIndex).

Condition 2: The first serving cell and the second serving cell both are associated with or operated with more than one TRP (e.g., two TRPs).

At least for condition 2, a serving cell being associated with or operated with two TRPs may mean that some CORESET(s) in the serving cell are configured/associated with a value of an index, where the value of the index may be different from that of other CORESET(s) in the serving cell. The index may be related to a TRP (e.g., CORESETPoolIndex).

Condition 3: The PDCCHs (CORESET(s), or the one or more PDSCH(s)) in the first serving cell to be applied the QCL assumption or TCI state are associated with a same (value of) the index as that of the RS (or the SSB), or the response for the first serving cell.

At least for condition 3, the (value of) the index may be a (value of) CORESETPoolIndex, a (value of) index related to TRP, or a (value of) Physical Identity (PCI). The (value of) the index may be a (value of) an index related to a panel for receiving the RS or the SSB.

Condition 4: The PDCCHs (CORESET(s), or the one or more PDSCH(s)) in the second serving cell to be applied the QCL assumption or TCI state are associated with a same (value of) an index as that of the RS (or the SSB), or the response for the first serving cell.

At least for condition 4, the (value of) the index may be a (value of) CORESETPoolIndex, a (value of) an index related to a TRP, a (value of) a PCI. The (value of) the index may be a (value of) an index related to a panel for receiving the RS or the SSB.

Condition 5: The UE receive an indication from the network.

At least for condition 5, the indication may be RRC signaling, or a MAC-CE, or downlink control information (DCI).

In some implementations, the response may be monitored or received by the UE in a search space. The search space may include one or more the following attributes:

1. A common search space;

2. A UE-specific search space or a search space dedicated to the UE;

3. A specific type (e.g., a type 3 search space);

4. Information associated with a CORESET used by another search space for an RA purpose (the another search space may be used for a Temporary Cell Radio Network Temporary Identifier (TC-RNTI) for msg-2 reception; the another search space may be a type 1 common search space);

5. A predetermined/pre-configured/configured search space. The predetermined/pre-configured/configured search space may not be associated with a CORESET configured/associated with a TCI state or QCL assumption. How the UE receives the predetermined/pre-configured/configured search space may be derived from the QCL assumption or TCI state for receiving the RS (or the SSB); and

6. A predetermined/pre-configured/configured search space. The predetermined/pre-configured/configured search space may be associated with a CORESET configured/associated with a TCI state or QCL assumption. The associated TCI state or QCL assumption may be released when a certain condition is fulfilled. For example, the condition may be related to a Contention Based Random Access (CBRA) based BFR that includes a BFRQ MAC-CE in Msg3 transmission or MsgA transmission. When the condition is met, the predetermined/pre-configured/configured search space received by the UE may be derived from the QCL assumption or TCI state for receiving the RS (or the SSB).

In some implementations, the response may be monitored or received in a CORESET. The CORESET may include one or more the following attributes:

1. A CORESET dedicated to the UE;

2. A predetermined/pre-configured/configured CORESET. The predetermined/pre-configured/configured CORESET may not be configured/associated with a TCI state or QCL assumption. How the UE receives the predetermined/pre-configured/configured CORESET may be derived from the QCL assumption or TCI state for receiving the RS (or the SSB); and

3. A CORESET used for a BFR procedure in a PCell or PSCell.

The response may be scrambled by an RNTI. The RNTI may be (only) used for scrambling (DL/UL) transmission related to a BFR procedure (e.g., the response). The RNTI may not be Cell Radio Network Temporary Identifier (C-RNTI). The RNTI may be BFR-RNTI. The RNTI may be a TC-RNTI.

IL UL beam (or spatial relation) update for one or more serving cells after successful BFR

In some implementations, when or after the UE receives the response, the UE may perform at least one of the following actions:

Action 1: Transmit one or more UL transmission(s) in the first serving cell via the spatial relation; and

Action 2: Transmit one or more UL transmission(s) in the first serving cell via at least one of the following power control factors: q_u=0, q_d=the RS or SSB, and 1=0.

In some implementations, when or after the UE receives the response, the UE may perform at least one of the following actions:

Action 1: Transmit one or more UL transmission(s) in the second serving cell via the spatial relation; and

Action 2: Transmit one or more UL transmission(s) in the second serving cell via at least one of the following power control factors: q_u=0, q_d=the RS or SSB, and 1=0.

In some implementations, when or after the UE receives the response, and if the second serving cell and the first serving cell are included in or associated with a same list (e.g., the first list or the second list), the UE may perform at least one of the following actions:

Action 1: Transmit one or more UL transmission(s) in the second serving cell via the spatial relation; and

Action 2: Transmit one or more UL transmission(s) in the second serving cell via at least one of the following power control factors: q_u=0, q_d=the RS or SSB, and 1=0.

In some implementations, when or after the UE receives the response, the UE may perform at least one of the following actions:

Action 1: Transmit one or more UL transmission(s) in other serving cell(s) via the spatial relation, where the said other serving cell(s) are included in a same list as the first serving cell (e.g., the first list or the second list); and

Action 2: Transmit one or more UL transmission(s) in other serving cell(s) via at least one of the following power control factors: q_u=0, q_d=the RS or SSB, and 1=0, where the said other serving cell(s) are included in a same list as the first serving cell (e.g., the first list or the second list).

The one or more UL transmission(s) may include one or more PUCCH resource(s), SRS resource(s), physical uplink shared channel (PUSCH) resource(s) or UL PRS resources(s).

At least for cases that the one or more UL transmissions include one or more PUCCH resource(s) in the first serving cell, at least one of the following conditions may be applied:

Condition 1: The one or more PUCCH resource(s) may be configured within a same PUCCH group in the first serving cell.

Condition 2: The one or more PUCCH resource(s) may be configured within a specific PUCCH group in the first serving cell.

The specific PUCCH group may be (pre-)configured or indicated, and/or the specific PUCCH group may be configured as being applicable to the spatial relation, and/or the specific PUCCH group may be a PUCCH group with a specific PUCCH group index (value) (e.g., index 0).

Condition 3: No PUCCH group is configured in the first serving cell or the active UL BWP in the first serving cell.

At least for cases that the one or more UL transmissions include one or more PUCCH resource(s) in the second serving cell, at least one of the following conditions may be applied:

Conditions 1: The one or more PUCCH resource(s) may be configured within a same PUCCH group in the second serving cell.

Conditions 2: The one or more PUCCH resource(s) may be configured within a specific PUCCH group in the second serving cell.

The specific PUCCH group may be (pre-)configured or indicated, and/or the specific PUCCH group may be configured as being applicable to the spatial relation, and/or the specific PUCCH group may be a PUCCH group with a specific PUCCH group index (value) (e.g., index 0).

Conditions 3: No PUCCH group is configured in the second serving cell or the active UL BWP in the second serving cell.

For the implementations mentioned above, the UE may apply the spatial relation only when the first serving cell is a PCell or PSCell.

For the implementations mentioned above, the UE may apply the spatial relation only when the first serving cell is an SCell.

For the implementations mentioned above, the UE may apply the spatial relation only when the first serving cell is a PCell or PSCell, and the second serving cell is an SCell.

For the or implementations mentioned above, the UE may apply the spatial relation only when the first serving cell is an SCell, and the second serving cell is an SCell.

Moreover, for the implementations mentioned above, the UE may apply the spatial relation in the first serving cell or the second serving cell until the UE receives a second signal.

The second signal may be used to (explicitly) indicate or configure another spatial relation for transmitting the one or more UL transmission(s) in the first serving cell or the second serving cell.

The another spatial relation may be the same as or different from the spatial relation.

Furthermore, for the implementations mentioned above, the UE may apply the spatial relation when at least one of the following conditions is satisfied:

Condition 1: The first serving cell and the second serving cell both are associated with or operated with (only) one TRP.

At least for condition 1, a serving cell being associated with or operated with (only) one TRP may mean that an index is not configured for some or all CORESET(s) in the serving cell, where the index may be related to a TRP (e.g., CORESETPoolIndex).

At least for condition 1, a serving cell being associated with or operated with (only) one TRP may mean that the value of an index, configured for or associated with some or all CORESET(s) in the serving cell, is restricted to a specific value (e.g., 0). In other words, none of CORESET(s) is configured with the value of the index set as 1. The index may be related to a TRP (e.g., CORESETPoolIndex)

Condition 2: The first serving cell and the second serving cell both are associated with or operated with more than one TRP (e.g., two TRPs).

At least for condition 2, a serving cell being associated with or operated with two TRPs may mean that some CORESET(s) in the serving cell are configured/associated with a value of an index, where the value of the index may be different from that of other CORESET(s) in the serving cell. The index may be related to a TRP (e.g., CORESETPoolIndex).

Condition 3: The one or more UL transmission(s) in the second serving cell to be applied the spatial relation are associated with a same (value of) index as that of the RS (or the SSB), or the response for the first serving cell. Alternatively, the one or more UL transmission(s) are scheduled by a CORESET associated with the same (value of) index as that of the RS or the SSB or the response for the first serving cell.

At least for condition 3, the (value of) the index may be (value of) CORESETPoolIndex, a (value of) an index related to a TRP, a (value of) a PCI. The (value of) the index may be a (value of) an index related to a panel for receiving the RS or the SSB. The (value of) the index may be a (value of) an index related to a panel for receiving the RS or the SSB, which implies that the reception of the RS or the SSB and the transmission of the one or more UL transmission(s) are performed via the same panel.

Condition 4: The UE may receive an indication from the network.

At least for condition 4, the indication may be RRC signalling, or an MAC-CE, or DCI.

In some implementations, the previously mentioned response may be monitored or received in a search space. The search space may include one or more the following attributes:

1. A common search space;

2. A UE-specific search space or a search space dedicated to the UE;

3. Information with a specific type (e.g., a type 3 search space);

4. Information associated with a CORESET used by another search space for an RA purpose (the another search space may be used for TC-RNTI for msg-2 reception; the another search space may be a type 1 common search space);

5. A predetermined/pre-configured/configured search space. The predetermined/pre-configured/configured search space may not be associated with a CORESET configured/associated with a TCI state or QCL assumption. How the UE receives the predetermined/pre-configured/configured search space may be derived from the QCL assumption or TCI state for receiving the RS (or the SSB); and

6. A predetermined/pre-configured/configured search space. The predetermined/pre-configured/configured search space may be associated with a CORESET configured/associated with a TCI state or QCL assumption. The associated TCI state or QCL assumption may be released when a certain condition is fulfilled. For example, the condition may be related to CBRA-based BFR which includes a BFRQ MAC-CE in Msg3 transmission or MsgA transmission. After the condition is met, how the UE receives the predetermined/pre-configured/configured search space may be derived from the QCL assumption or TCI state for receiving the RS (or the SSB).

In some implementations, the previously mentioned response may be monitored or received in a CORESET. The CORESET may include one or more the following attributes:

1. A CORESET dedicated to the UE;

2. A predetermined/pre-configured/configured CORESET. The predetermined/pre-configured/configured CORESET may not be configured/associated with a TCI state or QCL assumption. The predetermined/pre-configured/configured CORESET received by the UE may be derived from the QCL assumption or TCI state for receiving the RS (or the SSB); and

3. A CORESET used for a BFR procedure in a PCell or PSCell.

The response may be scrambled by an RNTI. The RNTI may be (only) used for scrambling (DL/UL) transmission related to a BFR procedure (e.g., the response). The RNTI may not be a C-RNTI. The RNTI may be a BFR-RNTI. The RNTI may be a TC-RNTI.

Based on the implementations mentioned above, after a successful BFR procedure, beams (spatial parameters) and power control parameters for performing transmission or reception among one or more serving cell(s) can be updated efficiently.

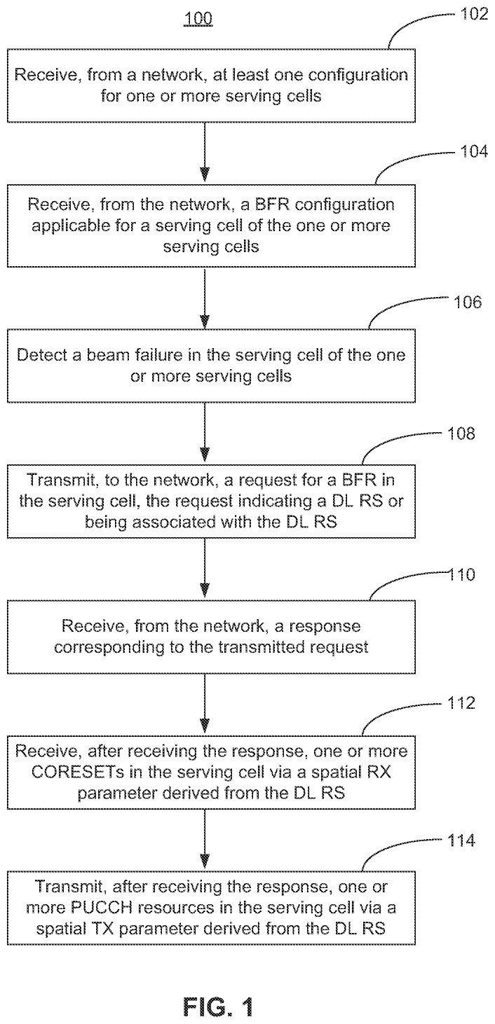

FIG. 1 is a flowchart illustrating a method of updating spatial parameters, according to an implementation of the present disclosure. In action 102, the UE receives, from a network, at least one configuration for one or more serving cells. In action 104, the UE receives, from the network, a BFR configuration applicable for a serving cell of the one or more serving cells. In action 106, the UE detects a beam failure in the serving cell of the one or more serving cells. In action 108, the UE transmits, to the network, a request for a BFR in the serving cell, the request indicating a DL RS or being associated with the DL RS. In action 110, the UE receives, from the network, a response corresponding to the transmitted request. In action 112, the UE receives, after receiving the response, one or more CORESETs in the serving cell via a spatial RX parameter derived from the DL RS. In action 114, the UE transmits, after receiving the response, one or more PUCCH resources in the serving cell via a spatial TX parameter derived from the DL RS.

In some examples, the UE may receive a PDCCH in the serving cell via the spatial RX parameter.

In some examples, the UE may receive a PDSCH in the serving cell via the spatial RX parameter.

In some examples, the UE may transmit a PUSCH in the serving cell via the spatial TX parameter.

In some examples, the UE may receive all CORESETs excluding the CORESET 0 in the serving cell via the spatial RX parameter.

In some examples, the previously mentioned serving cell is one of a PCell, a PSCell and a SCell.

In some examples, at least one of the PDCCH, the one or more CORESETs and the PDSCH in the serving cell to be applied with the spatial RX parameter are associated with a value of an index same as that of the DL RS, or that of the response. In other words, at least one of the PDCCH, the CORESET and the PDSCH, and the DL RS or the response are associated with the same value of the index.

In some examples, the PUSCH in the serving cell to be applied with the spatial TX parameter is associated with a value of an index as that of the DL RS, or that of the response. In other words, the PUSCH, and the DL RS or the response are associated with the same value of the index.

In some examples, the index includes at least one of a CORESETPoolIndex, an index related to a TRP, a PCI, and an index related to a panel for receiving the DL RS.

In some examples, the UE may receive, from the network, an indication to the UE to apply the spatial RX parameter for a DL reception in the serving cell.

In some examples, the UE may receive, from the network, an indication to the UE to apply the spatial TX parameter for an UL transmission in the serving cell.

The following paragraphs are related to a Physical Layer and may be implemented or performed by a UE or a network node.

Waveform, Numerology and Frame Structure

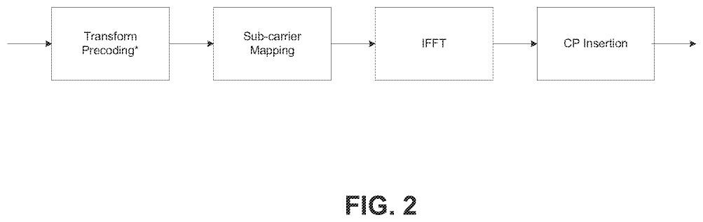

FIG. 2 is a schematic diagram illustrating a transmitter block diagram for Cyclic prefix Orthogonal Frequency Division Multiplexing (CP-OFDM) with optional discrete Fourier transform (DFT) spreading, according to an implementation of the present disclosure. The DL transmission waveform is conventional OFDM using a cyclic prefix. The UL transmission waveform is a conventional OFDM using a cyclic prefix with a transform precoding function performing DFT spreading that can be disabled or enabled. For operation with shared spectrum channel access, the UL transmission waveform subcarrier mapping can map to subcarriers in one or more Physical Resource Block (PRB) interlaces.

The numerology is based on exponentially scalable sub-carrier spacing Δf=2^{μ}×15 kHz with μ={0,1,3,4} for PSS, SSS and Physical Broadcast Channel (PBCH) and μ={0,1,2,3} for other channels. Normal CP is supported for all sub-carrier spacings, Extended CP is supported for μ=2. 12 consecutive sub-carriers form a PRB. Up to 275 PRBs are supported on a carrier. More details of supported transmission numerologies are illustrated in Table 1.

TABLE 1

| | Δf = | | Supported | Supported |
|---|---|---|---|---|
| μ | 2^{μ} · 15 [kHz] | Cyclic prefix | for data | for synch |
| 0 | 15 | Normal | Yes | Yes |
| 1 | 30 | Normal | Yes | Yes |
| 2 | 60 | Normal, Extended | Yes | No |
| 3 | 120 | Normal | Yes | Yes |
| 4 | 240 | Normal | No | Yes |

The UE may be configured with one or more bandwidth parts on a given component carrier (CC), of which only one can be active at a time, as described in the 3GPP TS 38.300 Rel-16 specification. The active bandwidth part defines the UE's operating bandwidth within the cell's operating bandwidth. For initial access, and until the UE's configuration in a cell is received, initial bandwidth part detected from system information is used.

DL and UL transmissions are organized into frames with 10 ms duration, consisting of ten 1 ms subframes. Each frame is divided into two equally-sized half-frames of five subframes each. The slot duration is 14 symbols with Normal CP and 12 symbols with Extended CP, and scales in time as a function of the used sub-carrier spacing so that there is always an integer number of slots in a subframe.

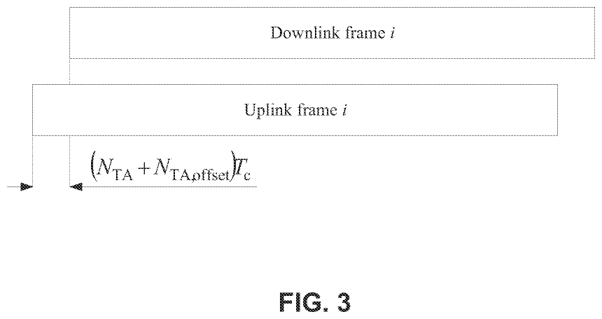

FIG. 3 is a schematic diagram illustrating an UL-DL timing relation, according to an implementation of the present disclosure. As illustrated in FIG. 3, a Timing Advance (TA) is used to adjust the UL frame timing (e.g., uplink frame i) relative to the DL frame timing (e.g., downlink frame i). Operation on both paired and unpaired spectrum is supported.

Downlink Transmission Scheme

A closed loop Demodulation Reference Signal (DMRS) based spatial multiplexing is supported for the PDSCH. Up to 8 and 12 orthogonal DL DMRS ports are supported for type 1 and type 2 DMRS respectively. Up to 8 orthogonal DL DMRS ports per UE are supported for Single-User Multi-User Multiple Input Multiple Output (SU-MIMO) and up to 4 orthogonal DL DMRS ports per UE are supported for Multi-User Multiple Input Multiple Output (MU-MIMO). The number of SU-MIMO code words is one for 1-4 layer transmissions and two for 5-8 layer transmissions.

The DMRS and corresponding PDSCH are transmitted using the same precoding matrix and the UE does not need to know the precoding matrix to demodulate the transmission. The transmitter may use different precoder matrix for different parts of the transmission bandwidth, resulting in frequency selective precoding. The UE may also assume that the same precoding matrix is used across a set of PRBs denoted Precoding Resource Block Group (PRG). Transmission durations from 2 to 14 symbols in a slot is supported. Aggregation of multiple slots with Transport Block (TB) repetition is supported.

Physical-Layer Processing for PDSCH

The DL physical-layer processing of transport channels consists of the following steps:
Transport block Cyclic Redundancy Check (CRC) attachment;
Code block segmentation and code block CRC attachment;
Channel coding: Low Density Parity Check (LDPC) coding;
Physical-layer hybrid-ARQ processing;
Rate matching;
Scrambling;
Modulation: Quadrature Phase Shift Keying (QPSK), 16 Quadrature Amplitude Modulation (QAM), 64QAM and 256QAM;
Layer mapping; and
Mapping to assigned resources and antenna ports.

The UE may assume that at least one symbol with demodulation reference signal is present on each layer in which PDSCH is transmitted to a UE, and up to 3 additional DMRS can be configured by higher layers.

Phase Tracking RS may be transmitted on additional symbols to aid receiver phase tracking.

The DL shared channel (SCH) physical layer model is described in the 3GPP TS 38.202.

PDCCHs

The PDCCH can be used to schedule DL transmissions on PDSCH and UL transmissions on PUSCH, where the DCI on PDCCH includes:
DL assignments containing at least modulation and coding format, resource allocation, and hybrid-ARQ information related to DL-SCH;
UL scheduling grants containing at least modulation and coding format, resource allocation, and hybrid-ARQ information related to UL-SCH.

In addition to scheduling, PDCCH can be used to for:
Activation and deactivation of configured PUSCH transmission with configured grant;
Activation and deactivation of PDSCH semi-persistent transmission;
Notifying one or more UEs of the slot format;
Notifying one or more UEs of the PRB(s) and OFDM symbol(s) where the UE may assume no transmission is intended for the UE;
Transmission of Transmission Power Control (TPC) commands for PUCCH and PUSCH;
Transmission of one or more TPC commands for SRS transmissions by one or more UEs;
Switching a UE's active bandwidth part;
Initiating a RA procedure;
Indicating the UE(s) to monitor the PDCCH during the next occurrence of the Discontinuous Reception (DRX) on-duration; and
In Integrated Access and Backhaul (IAB) context, indicating the availability for soft symbols of an IAB distributed unit (IAB-DU).

A UE monitors a set of PDCCH candidates in the configured monitoring occasions in one or more configured CORESETs according to the corresponding search space configurations.

A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

SSB

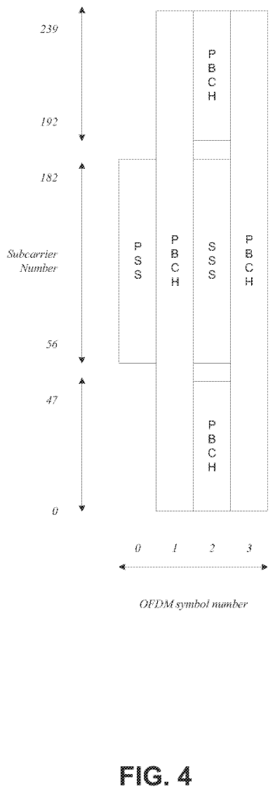

FIG. 4 is a schematic diagram illustrating a time-frequency structure of Synchronization Signal and Physical Broadcast Channel (PBCH) Block (SSB), according to an implementation of the present disclosure. The SSB consists of primary and secondary synchronization signals (PSS, SSS), each occupying 1 symbol and 127 subcarriers, and PBCH spanning across 3 OFDM symbols and 240 subcarriers (0 to 239), but on one symbol leaving an unused part in the middle for SSS as show in FIG. 4. The possible time locations of SSBs within a half-frame are determined by sub-carrier spacing and the periodicity of the half-frames where SSBs are transmitted is configured by the network. During a half-frame, different SSBs may be transmitted in different spatial directions (e.g., using different beams, spanning the coverage area of a cell).

Within the frequency span of a carrier, multiple SSBs can be transmitted. The PCIs of SSBs transmitted in different frequency locations do not have to be unique (e.g., different SSBs in the frequency domain can have different PCIs). However, when an SSB is associated with a Remaining Minimum System Information (RMSI), the SSB corresponds to an individual cell, which has a unique NR Cell Global Identifier (NCGI). Such an SSB is referred to as a Cell-Defining SSB (CD-SSB). A PCell is always associated to a CD-SSB located on the synchronization raster. Polar coding is used for PBCH. The UE may assume a band-specific sub-carrier spacing for the SSB unless a network has configured the UE to assume a different sub-carrier spacing. PBCH symbols carry its own frequency-multiplexed DMRS. QPSK modulation is used for PBCH. The PBCH physical layer model is described in the 3GPP TS 38.202.

Physical Layer Procedures

Link Adaptation

Link adaptation (e.g., adaptive modulation and coding (AMC)) with various modulation schemes and channel coding rates is applied to the PDSCH. The same coding and modulation is applied to all groups of resource blocks belonging to the same L2 PDU scheduled to one user within one transmission duration and within a MIMO codeword.

For channel state estimation purposes, the UE may be configured to measure CSI-RS and estimate the downlink channel state based on the CSI-RS measurements. The UE feeds the estimated channel state back to the gNB to be used in link adaptation.

Power Control

Downlink power control can be used.

Cell Search

Cell search is the procedure by which a UE acquires time and frequency synchronization with a cell and detects the Cell ID of that cell. NR cell search is based on the primary and secondary synchronization signals, and PBCH DMRS, located on the synchronization raster.

Hybrid Automatic Repeat Request (HARQ)

Asynchronous Incremental Redundancy Hybrid ARQ is supported. The gNB provides the UE with the HARQ Acknowledgement (ACK) feedback timing either dynamically in the DCI or semi-statically in an RRC configuration. Retransmission of HARQ-ACK feedback is supported for operation with shared spectrum channel access by using enhanced dynamic codebook and/or one-shot triggering of HARQ-ACK transmission for all configured CCs and HARQ processes in the PUCCH group.

The UE may be configured to receive code block group-based transmissions where retransmissions may be scheduled to carry a sub-set of all the code blocks of a TB.

Reception of System Information Block 1 (SIB1)

The Master Information Block (MIB) on PBCH provides the UE with parameters (e.g., CORESET #0 configuration) for monitoring of PDCCH for scheduling PDSCH that carries the SIB1. PBCH may also indicate that there is no associated SIB1, in which case the UE may be pointed to another frequency from where to search for an SSB that is associated with a SIB1 as well as a frequency range where the UE may assume no SSB associated with SIB1 is present. The indicated frequency range is confined within a contiguous spectrum allocation of the same operator in which SSB is detected.

DL RSs and Measurements for Positioning

The DL Positioning Reference Signals (DL PRS) are defined to facilitate support of different positioning methods such as DL Time Difference of Arrival (TDOA), DL Angle of departure (AoD), multi Round Trip Time (RTT) through the following set of UE measurements DL Reference Signal Time Difference (RSTD), DL PRS Reference Signal Received Power (RSRP), and UE Rx-Tx time difference respectively as described in the 3GPP TS 38.305.

Besides DL PRS signals, UE can use SSB and CSI-RS for RRM (e.g., RSRP and RSRQ) measurements for Enhanced Cell D (E-CID) type of positioning.

UL Transmission Scheme

Two transmission schemes are supported for PUSCH: codebook-based transmission and non-codebook-based transmission.

For codebook-based transmission, the gNB provides the UE with a transmit precoding matrix indication in the DCI. The UE uses the indication to select the PUSCH transmit precoder from the codebook. For non-codebook-based transmission, the UE determines its PUSCH precoder based on wideband SRI field from the DCI.

A closed loop DMRS based spatial multiplexing is supported for PUSCH. For a given UE, up to 4 layer transmissions are supported. The number of code words is one. When transform precoding is used, only a single MIMO layer transmission is supported. Transmission durations from 1 to 14 symbols in a slot is supported. Aggregation of multiple slots with TB repetition is supported.

Two types of frequency hopping are supported, intra-slot frequency hopping, and in case of slot aggregation, inter-slot frequency hopping. Intra-slot and inter-slot frequency hopping are not supported when PRB interlace uplink transmission waveform is used.

PUSCH may be scheduled with DCI on PDCCH, or a semi-static configured grant may be provided over RRC, where two types of operation are supported:
The first PUSCH is triggered with a DCI, with subsequent PUSCH transmissions following the RRC configuration and scheduling received on the DCI; and
The PUSCH is triggered by data arrival to the UE's transmit buffer and the PUSCH transmissions follow the RRC configuration.

Physical-Layer Processing for PUSCH

The uplink physical-layer processing of transport channels consists of the following steps:
TB CRC attachment;
Code block segmentation and Code Block CRC attachment;
Channel coding: LDPC coding;
Physical-layer hybrid-ARQ processing;
Rate matching;
Scrambling;
Modulation: π/2 BPSK (with transform precoding only), QPSK, 16QAM, 64QAM and 256QAM;
Layer mapping, transform precoding (enabled/disabled by configuration), and pre-coding; and
Mapping to assigned resources and antenna ports.

The UE transmits at least one symbol with demodulation reference signal on each layer on each frequency hop in which the PUSCH is transmitted, and up to 3 additional DMRS can be configured by higher layers. Phase Tracking RS may be transmitted on additional symbols to aid receiver phase tracking. The UL-SCH physical layer model is described in the 3GPP TS 38.202. For configured grants operation with shared spectrum channel access, a Configured Grant Uplink Control Information (CG-UCI) is transmitted in PUSCH scheduled by configured UL grant.

PUCCH

PUCCH carries the UCI from the UE to the gNB. Five formats of PUCCH exist, depending on the duration of PUCCH and the UCI payload size.
Format #0: Short PUCCH of 1 or 2 symbols with small UCI payloads of up to two bits with UE multiplexing capacity of up to 6 UEs with 1-bit payload in the same PRB;
Format #1: Long PUCCH of 4-14 symbols with small UCI payloads of up to two bits with UE multiplexing capacity of up to 84 UEs without frequency hopping and 36 UEs with frequency hopping in the same PRB;
Format #2: Short PUCCH of 1 or 2 symbols with large UCI payloads of more than two bits with no UE multiplexing capability in the same PRBs;
Format #3: Long PUCCH of 4-14 symbols with large UCI payloads with no UE multiplexing capability in the same PRBs; and
Format #4: Long PUCCH of 4-14 symbols with moderate UCI payloads with multiplexing capacity of up to 4 UEs in the same PRBs.

The short PUCCH format of up to two UCI bits is based on sequence selection, while the short PUCCH format of more than two UCI bits frequency multiplexes UCI and DMRS. The long PUCCH formats time-multiplex the UCI and DMRS. Frequency hopping is supported for long PUCCH formats and for short PUCCH formats of duration of 2 symbols. Long PUCCH formats can be repeated over multiple slots.

For operation with shared spectrum channel access, PUCCH Format #0, #1, #2, #3 are extended to use resource in one PRB interlace (up to two interlaces for Format #2 and Format #3) in one RB Set. PUCCH Format #2 and #3 are enhanced to support multiplexing capacity of up to 4 UEs in the same PRB interlace when one interlace is used.

UCI multiplexing in PUSCH is supported when UCI and PUSCH transmissions coincide in time, either due to transmission of a UL-SCH transport block or due to triggering of A-CSI transmission without UL-SCH transport block:
UCI carrying HARQ-ACK feedback with 1 or 2 bits is multiplexed by puncturing PUSCH; and
In all other cases UCI is multiplexed by rate matching PUSCH.

UCI consists of the following information:
CSI;
ACK/NAK; and
Scheduling request.

For operation with shared spectrum channel access, multiplexing of CG-UCI and PUCCH carrying HARQ-ACK feedback can be configured by the gNB. If not configured, when PUCCH overlaps with PUSCH scheduled by a configured grant within a PUCCH group and PUCCH carries HARQ ACK feedback, PUSCH scheduled by configured grant is skipped.

QPSK and π/2 BPSK modulation can be used for long PUCCH with more than 2 bits of information, QPSK is used for short PUCCH with more than 2 bits of information and BPSK and QPSK modulation can be used for long PUCCH with up to 2 information bits. Transform precoding is applied to PUCCH Format #3 and Format #4.

Channel coding used for UCI is illustrated in Table 2.

TABLE 2

| Uplink Control Information | |
|---|---|
| size including CRC, if present | Channel code |
| 1 | Repetition code |
| 2 | Simplex code |
| 3-11 | Reed Muller code |
| >11 | Polar code |

RA

The RA preamble sequences of four different lengths are supported. Sequence length 839 is applied with subcarrier spacings of 1.25 and 5 kHz, sequence length 139 is applied with subcarrier spacings of 15, 30, 60 and 120 kHz, and sequence lengths of 571 and 1151 are applied with subcarrier spacings of 30 kHz and 15 kHz respectively. Sequence length 839 supports unrestricted sets and restricted sets of Type A and Type B, while sequence lengths 139, 571, and 1151 support unrestricted sets only. Sequence length 839 is only used for operation with licensed channel access while sequence length 139 can be used for operation with either licensed or shared spectrum channel access. Sequence lengths of 571 and 1151 can be used only for operation with shared spectrum channel access.

Multiple PRACH preamble formats are defined with one or more PRACH OFDM symbols, and different cyclic prefix and guard time. The PRACH preamble configuration to use is provided to the UE in the system information.

For IAB, additional RA configurations are defined. These configurations are obtained by extending the RA configurations defined for UEs via scaling the periodicity and/or offsetting the time domain position of the RACH occasions.

IAB-MTs can be provided with RA configurations (as defined for UEs or after applying the aforementioned scaling/offsetting) different from random access configurations provided to UEs.

The UE calculates the PRACH transmit power for the retransmission of the preamble based on the most recent estimate pathloss and power ramping counter.

The system information provides information for the UE to determine the association between the SSB and the RACH resources. The RSRP threshold for SSB selection for RACH resource association is configurable by network.

Physical Layer Procedures

Link Adaptation

Four types of link adaptation are supported as follows:
Adaptive transmission bandwidth;
Adaptive transmission duration;
Transmission power control; and
Adaptive modulation and channel coding rate.

For channel state estimation purposes, the UE may be configured to transmit SRS that the gNB may use to estimate the UL channel state and use the estimate in link adaptation.

UL Power Control

The gNB determines the desired UL transmit power and provides UL transmit power control commands to the UE. The UE uses the provided UL transmit power control commands to adjust its transmit power.

UL Timing Control

The gNB determines the desired TA setting and provides that to the UE. The UE uses the provided TA to determine its UL transmit timing relative to the UE's observed DL receive timing.

HARQ

Asynchronous Incremental Redundancy Hybrid ARQ is supported. The gNB schedules each uplink transmission and retransmission using the uplink grant on DCI. For operation with shared spectrum channel access, UE can also retransmit on configured grants.

The UE may be configured to transmit code block group-based transmissions where retransmissions may be scheduled to carry a sub-set of all the code blocks of a transport block.

Up to two HARQ-ACK codebooks corresponding to a priority (high/low) can be constructed simultaneously. For each HARQ-ACK codebook, more than one PUCCH for HARQ-ACK transmission within a slot is supported. Each PUCCH is limited within one sub-slot, and the sub-slot pattern is configured per HARQ-ACK codebook.

Prioritization of Overlapping Transmissions

PUSCH and PUCCH can be associated with a priority (e.g., high/low) by RRC or L1 signalling. If a PUCCH transmission overlaps in time with a transmission of a PUSCH or another PUCCH, only the PUCCH or PUSCH associated with a high priority can be transmitted.

UL RSs and Measurements for Positioning

The periodic, semipersistent and aperiodic transmission of SRS is defined for gNB UL Relative Time of Arrival (RTOA), UL SRS-RSRP, UL Angle of Arrival (AoA) measurements to facilitate support of UL TDOA and UL AoA positioning methods as described in the 3GPP TS 38.305.

The periodic, semipersistent and aperiodic transmission of SRS for positioning is defined for gNB UL RTOA, UL SRS-RSRP, UL-AoA, gNB Rx-Tx time difference measurements to facilitate support of UL TDOA, UL AoA and multi-RTT positioning methods as described in the 3GPP TS 38.305.

Carrier Aggregation (CA)

In the CA, two or more CCs are aggregated. A UE may simultaneously receive or transmit on one or multiple CCs depending on its capabilities:
A UE with single timing advance capability for CA can simultaneously receive and/or transmit on multiple CCs corresponding to multiple serving cells sharing the same timing advance (multiple serving cells grouped in one Time Alignment Group (TAG));
A UE with multiple timing advance capability for CA can simultaneously receive and/or transmit on multiple CCs corresponding to multiple serving cells with different timing advances (multiple serving cells grouped in multiple TAGs). NG-RAN ensures that each TAG contains at least one serving cell; and
A non-CA capable UE can receive on a single CC and transmit on a single CC corresponding to one serving cell only (one serving cell in one TAG).

CA is supported for both contiguous and non-contiguous CCs. When CA is deployed frame timing and System Frame Number (SFN) are aligned across cells that can be aggregated, or an offset in multiples of slots between the PCell/PSCell and an SCell is configured to the UE. The maximum number of configured CCs for a ULE is 16 for DL and 16 for UL.

Supplementary UL

In conjunction with a UL/DL carrier pair (FDD band) or a bidirectional carrier (TDD band), a UE may be configured with additional, Supplementary Uplink (SUL). SUL differs from the aggregated UL in that the UE may be scheduled to transmit either on the supplementary UL or on the UL of the carrier being supplemented, but not on both at the same time.

RA Resource Selection

If the selected RA_TYPE is set to 4-stepRA, the MAC entity shall:

1> if the Random Access procedure was initiated for SpCell beam failure recovery (as specified in the 3GPP TS 38.321); and
1> if the beamFailureRecoveryTimer is either running or not configured; and
1> if the contention-free Random Access Resources for beam failure recovery request associated with any of the SSBs and/or CSI-RSs have been explicitly provided by RRC; and
1> if at least one of the SSBs with synchronization signal (SS) RSRP above rsrp-ThresholdSSB among the SSBs in candidateBeamRSList or the CSI-RSs with CSI-RSRP above rsrp-ThresholdCSI-RS among the CSI-RSs in candidateBeamRSList is available:

2> select an SSB with SS-RSRP above rsrp-ThresholdSSB among the SSBs in candidateBeamRSList or a CSI-RS with CSI-RSRP above rsrp-ThresholdCSI-RS among the CSI-RSs in candidateBeamRSList;

2> if CSI-RS is selected, and there is no ra-PreambleIndex associated with the selected CSI-RS:
3> set the PREAMBLE_INDEX to a ra-PreambleIndex corresponding to the SSB in candidateBeamRSList which is quasi-co-located with the selected CSI-RS as specified in the 3GPP TS 38.214.

2> else:
3> set the PREAMBLE_INDEX to a ra-PreambleIndex corresponding to the selected SSB or CSI-RS from the set of Random Access Preambles for beam failure recovery request.
   1> else if the ra-PreambleIndex has been explicitly provided by PDCCH; and
   1> if the ra-PreambleIndex is not 0b000000:

2> set the PREAMBLE_INDEX to the signalled ra-PreambleIndex;

2> select the SSB signalled by PDCCH.

1> else if the contention-free Random Access Resources associated with SSBs have been explicitly provided in rach-ConfigDedicated and at least one SSB with SS-RSRP above rsrp-ThresholdSSB among the associated SSBs is available:

2> select an SSB with SS-RSRP above rsrp-ThresholdSSB among the associated SSBs;

2> set the PREAMBLE_INDEX to a ra-PreambleIndex corresponding to the selected SSB.

1> else if the contention-free Random Access Resources associated with CSI-RSs have been explicitly provided in rach-ConfigDedicated and at least one CSI-RS with CSI-RSRP above rsrp-ThresholdCSI-RS among the associated CSI-RSs is available:

2> select a CSI-RS with CSI-RSRP above rsrp-ThresholdCSI-RS among the associated CSI-RSs;

2> set the PREAMBLE_INDEX to a ra-PreambleIndex corresponding to the selected CSI-RS.

1> else if the Random Access procedure was initiated for SI request (as specified in the 3GPP TS 38.331); and
1> if the Random Access Resources for SI request have been explicitly provided by RRC:

2> if at least one of the SSBs with SS-RSRP above rsrp-ThresholdSSB is available:
3> select an SSB with SS-RSRP above rsrp-ThresholdSSB.

2> else:
3> select any SSB.

2> select a Random Access Preamble corresponding to the selected SSB, from the Random Access Preamble(s) determined according to ra-PreambleStartIndex as specified in the 3GPP TS 38.331;

2> set the PREAMBLE_INDEX to selected Random Access Preamble.

1> else (e.g., for the contention-based Random Access preamble selection):

2> if at least one of the SSBs with SS-RSRP above rsrp-ThresholdSSB is available:
3> select an SSB with SS-RSRP above rsrp-ThresholdSSB.

2> else:
3> select any SSB.

2> if the RA_TYPE is switched from 2-stepRA to 4-stepRA:
3> if a Random Access Preambles group was selected during the current Random Access procedure:
   4> select the same group of Random Access Preambles as was selected for the 2-step RA type.
3> else:
   4> if Random Access Preambles group B is configured; and
   4> if the transport block size of the MSGA payload configured in the rach-ConfigDedicated corresponds to the transport block size of the MSGA payload associated with Random Access Preambles group B:
      5> select the Random Access Preambles group B.
   4> else:
      5> select the Random Access Preambles group A.

2> else if Msg3 buffer is empty:
3> if Random Access Preambles group B is configured:
   4> if the potential Msg3 size (UL data available for transmission plus MAC header and, where required, MAC CEs) is greater than ra-Msg3SizeGroupA and the pathloss is less than PCMAX (of the Serving Cell performing the Random Access Procedure)−preambleReceivedTargetPower−msg3-DeltaPreamble−messagePowerOffsetGroupB; or
   4> if the Random Access procedure was initiated for the CCCH logical channel and the CCCH SDU size plus MAC subheader is greater than ra-Msg3SizeGroupA:
      5> select the Random Access Preambles group B.
   4> else:
      5> select the Random Access Preambles group A.
3> else:
   4> select the Random Access Preambles group A.

2> else (e.g., Msg3 is being retransmitted):
3> select the same group of Random Access Preambles as was used for the Random Access Preamble transmission attempt corresponding to the first transmission of Msg3.

2> select a Random Access Preamble randomly with equal probability from the Random Access Preambles associated with the selected SSB and the selected Random Access Preambles group.

2> set the PREAMBLE_INDEX to the selected Random Access Preamble.

1> if the Random Access procedure was initiated for SI request (as specified in the 3GPP TS 38.331); and
1> if ra-AssociationPeriodIndex and si-RequestPeriod are configured:

2> determine the next available PRACH occasion from the PRACH occasions corresponding to the selected SSB in the association period given by ra-AssociationPeriodIndex in the si-RequestPeriod permitted by the restrictions given by the ra-ssb-OccasionMaskIndex if configured (the MAC entity shall select a PRACH occasion randomly with equal probability among the consecutive PRACH occasions according to the 3GPP TS 38.213).

1> else if an SSB is selected above:

2> determine the next available PRACH occasion from the PRACH occasions corresponding to the selected SSB permitted by the restrictions given by the ra-ssb-OccasionMaskIndex if configured or indicated by PDCCH (the MAC entity shall select a PRACH occasion randomly with equal probability among the consecutive PRACH occasions according to the 3GPP TS 38.213, corresponding to the selected SSB; the MAC entity may take into account the possible occurrence of measurement gaps when determining the next available PRACH occasion corresponding to the selected SSB).

1> else if a CSI-RS is selected above:

2> if there is no contention-free Random Access Resource associated with the selected CSI-RS:
3> determine the next available PRACH occasion from the PRACH occasions, permitted by the restrictions given by the ra-ssb-OccasionMaskIndex if configured, corresponding to the SSB in candidateBeamRSList which is quasi-co-located with the selected CSI-RS as specified in the 3GPP TS 38.214 (the MAC entity shall select a PRACH occasion randomly with equal probability among the consecutive PRACH occasions according to the 3GPP TS 38.213, corresponding to the SSB which is quasi-co-located with the selected CSI-RS; the MAC entity may take into account the possible occurrence of measurement gaps when determining the next available PRACH occasion corresponding to the SSB which is quasi-co-located with the selected CSI-RS).

2> else:
3> determine the next available PRACH occasion from the PRACH occasions in ra-OccasionList corresponding to the selected CSI-RS (the MAC entity shall select a PRACH occasion randomly with equal probability among the PRACH occasions occurring simultaneously but on different subcarriers, corresponding to the selected CSI-RS; the MAC entity may take into account the possible occurrence of measurement gaps when determining the next available PRACH occasion corresponding to the selected CSI-RS).
   1> perform the Random Access Preamble transmission procedure (as specified in the 3GPP TS 38.321).

NOTE 1: When the UE determines if there is an SSB with SS-RSRP above rsrp-ThresholdSSB or a CSI-RS with CSI-RSRP above rsrp-ThresholdCSI-RS, the UE uses the latest unfiltered L1-RSRP measurement.

NOTE 2: For a UE operating in a semi-static channel access mode as described in the 3GPP TS 37.213, Random Access Resources overlapping with the idle time of a fixed frame period are not considered for selection.

RA Resource Selection for 2-Step RA Type

If the selected RA_TYPE is set to 2-stepRA, the MAC entity shall:

1> if the contention-free 2-step RA type Resources associated with SSBs have been explicitly provided in rach-ConfigDedicated and at least one SSB with SS-RSRP above msgA-RSRP-ThresholdSSB among the associated SSBs is available:

2> select an SSB with SS-RSRP above msgA-RSRP-ThresholdSSB among the associated SSBs;

2> set the PREAMBLE_INDEX to a ra-PreambleIndex corresponding to the selected SSB.

1> else (e.g., for the contention-based Random Access Preamble selection):

2> if at least one of the SSBs with SS-RSRP above msgA-RSRP-ThresholdSSB is available:
3> select an SSB with SS-RSRP above msgA-RSRP-ThresholdSSB.

2> else:
3> select any SSB.

2> if contention-free Random Access Resources for 2-step RA type have not been configured and if Random Access Preambles group has not yet been selected during the current Random Access procedure:
3> if Random Access Preambles group B for 2-step RA type is configured:
   4> if the potential MSGA payload size (UL data available for transmission plus MAC header and, where required, MAC CEs) is greater than the ra-Msg-ASizeGroupA and the pathloss is less than PCMAX (of the Serving Cell performing the Random Access Procedure)−msgA-PreambleReceivedTargetPower−msgA-DeltaPreamble−msgA-messagePowerOffsetGroupB; or
   4> if the Random Access procedure was initiated for the CCCH logical channel and the CCCH SDU size plus MAC subheader is greater than ra-MsgA-SizeGroupA:
      5> select the Random Access Preambles group B.
   4> else:
      5> select the Random Access Preambles group A.
3> else:
   4> select the Random Access Preambles group A.

2> else if contention-free Random Access Resources for 2-step RA type have been configured and if Random Access Preambles group has not yet been selected during the current Random Access procedure:
3> if Random Access Preambles group B for 2-step RA type is configured; and
3> if the transport block size of the MSGA payload configured in the rach-ConfigDedicated corresponds to the transport block size of the MSGA payload associated with Random Access Preambles group B:
   4> select the Random Access Preambles group B.
3> else:
   4> select the Random Access Preambles group A.

2> else (e.g., Random Access preambles group has been selected during the current Random Access procedure):
3> select the same group of Random Access Preambles as was used for the Random Access Preamble transmission attempt corresponding to the earlier transmission of MSGA.

2> select a Random Access Preamble randomly with equal probability from the 2-step RA type Random Access Preambles associated with the selected SSB and the selected Random Access Preambles group;

2> set the PREAMBLE_INDEX to the selected Random Access Preamble;

1> determine the next available PRACH occasion from the PRACH occasions corresponding to the selected SSB permitted by the restrictions given by the msgA-SSB-SharedRO-MaskIndex if configured and ra-ssb-OccasionMaskIndex if configured (the MAC entity shall select a PRACH occasion randomly with equal probability among the consecutive PRACH occasions allocated for 2-step RA type according to the 3GPP TS 38.213, corresponding to the selected SSB; the MAC entity may take into account the possible occurrence of measurement gaps when determining the next available PRACH occasion corresponding to the selected SSB);
1> if the Random Access Preamble was not selected by the MAC entity among the contention-based Random Access Preamble(s):

2> select a PUSCH occasion from the PUSCH occasions configured in msgA-CFRA-PUSCH corresponding to the PRACH slot of the selected PRACH occasion, according to msgA-PUSCH-resource-Index corresponding to the selected SSB;

2> determine the UL grant and the associated HARQ information for the MSGA payload in the selected PUSCH occasion;

2> deliver the UL grant and the associated HARQ information to the HARQ entity.

1> else:

2> select a PUSCH occasion corresponding to the selected preamble and PRACH occasion according to the 3GPP TS 38.213;

2> determine the UL grant for the MSGA payload according to the PUSCH configuration associated with the selected Random Access Preambles group and determine the associated HARQ information;

2> if the selected preamble and PRACH occasion is mapped to a valid PUSCH occasion as specified in the 3GPP TS 38.213:
3> deliver the UL grant and the associated HARQ information to the HARQ entity.
   1> perform the MSGA transmission procedure.

NOTE: To determine if there is an SSB with SS-RSRP above msgA-RSRP-ThresholdSSB, the UE uses the latest unfiltered L1-RSRP measurement.

RA Preamble Transmission

The MAC entity shall, for each Random Access Preamble:

1> if PREAMBLE_TRANSMISSION_COUNTER is greater than one; and
1> if the notification of suspending power ramping counter has not been received from lower layers; and
1> if LBT failure indication was not received from lower layers for the last Random Access Preamble transmission; and
1> if SSB or CSI-RS selected is not changed from the selection in the last Random Access Preamble transmission:

2> increment PREAMBLE_POWER_RAMPING_COUNTER by 1.

1> select the value of DELTA_PREAMBLE;
1> set PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA;
1> except for contention-free Random Access Preamble for beam failure recovery request, compute the RA-RNTI associated with the PRACH occasion in which the Random Access Preamble is transmitted;
1> instruct the physical layer to transmit the Random Access Preamble using the selected PRACH occasion, corresponding RA-RNTI (if available), PREAMBLE_INDEX and PREAMBLE_RECEIVED_TARGET_POWER.
1> if LBT failure indication is received from lower layers for this Random Access Preamble transmission:

2> if lbt-FailureRecoveryConfig is configured:
3> perform the Random Access Resource selection procedure.

2> else:
3> increment PREAMBLE_TRANSMISSION_COUNTER by 1;
3> if PREAMBLE_TRANSMISSION_COUNTER=preamble TransMax+1:
   4> if the Random Access Preamble is transmitted on the SpCell:
      5> indicate a Random Access problem to upper layers;
      5> if this Random Access procedure was triggered for SI request:
         6> consider the Random Access procedure unsuccessfully completed.
   4> else if the Random Access Preamble is transmitted on an SCell:
      5> consider the Random Access procedure unsuccessfully completed.
3> if the Random Access procedure is not completed:
   4> perform the Random Access Resource selection procedure.

The RA-RNTI associated with the PRACH occasion in which the Random Access Preamble is transmitted, is computed as:

RA-RNTI=1+s_id+14×t_id+14×80×f_id+14×80×8×ul_carrier_id,

where s_id is the index of the first OFDM symbol of the PRACH occasion (0≤s_id<14), t_id is the index of the first slot of the PRACH occasion in a system frame (0≤t_id<80), where the subcarrier spacing to determine t_id is based on the value of specified in the 3GPP TS 38.211, f_id is the index of the PRACH occasion in the frequency domain (0≤f_id<8), and ul_carrier_id is the UL carrier used for Random Access Preamble transmission (0 for NUL carrier, and 1 for SUL carrier).

MSGA Transmission

The MAC entity shall, for each MSGA:

1> if PREAMBLE_TRANSMISSION_COUNTER is greater than one; and
1> if the notification of suspending power ramping counter has not been received from lower layers; and
1> if LBT failure indication was not received from lower layers for the last MSGA Random Access Preamble transmission; and
1> if SSB selected is not changed from the selection in the last Random Access Preamble transmission:

2> increment PREAMBLE_POWER_RAMPING_COUNTER by 1.

1> select the value of DELTA_PREAMBLE;
1> set PREAMBLE_RECEIVED_TARGET_POWER to msgA-PreambleReceivedTargetPower+DELTA_PREAMBLE+(PREAMBLE_POWER_RAMPING_COUNTER−1)×PREAMBLE_POWER_RAMPING_STEP;
1> if this is the first MSGA transmission within this Random Access procedure:

2> if the transmission is not being made for the CCCH logical channel:
3> indicate to the Multiplexing and assembly entity to include a C-RNTI MAC CE in the subsequent uplink transmission.

2> if the Random Access procedure was initiated for SpCell beam failure recovery:
3> indicate to the Multiplexing and assembly entity to include a BFR MAC CE or a Truncated BFR MAC CE in the subsequent uplink transmission.

2> obtain the MAC PDU to transmit from the Multiplexing and assembly entity according to the HARQ information determined for the MSGA payload and store it in the MSGA buffer.

1> compute the MSGB-RNTI associated with the PRACH occasion in which the Random Access Preamble is transmitted;
1> instruct the physical layer to transmit the MSGA using the selected PRACH occasion and the associated PUSCH resource of MSGA (if the selected preamble and PRACH occasion is mapped to a valid PUSCH occasion), using the corresponding RA-RNTI, MSGB-RNTI, PREAMBLE_INDEX, PREAMBLE_RECEIVED_TARGET_POWER, msgA-PreambleReceivedTargetPower, and the amount of power ramping applied to the latest MSGA preamble transmission (e.g., (PREAMBLE_POWER_RAMPING_COUNTER−1)×PREAMBLE_POWER_RAMPING_STEP);
1> if LBT failure indication is received from lower layers for the transmission of this MSGA Random Access Preamble:

2> instruct the physical layer to cancel the transmission of the MSGA payload on the associated PUSCH resource;

2> if lbt-FailureRecoveryConfig is configured:
3> perform the Random Access Resource selection procedure for 2-step RA type.

2> else:
3> increment PREAMBLE_TRANSMISSION_COUNTER by 1;
3> if PREAMBLE_TRANSMISSION_COUNTER=preamble TransMax+1:
   4> indicate a Random Access problem to upper layers;
   4> if this Random Access procedure was triggered for SI request:
      5> consider this Random Access procedure unsuccessfully completed.
3> if the Random Access procedure is not completed:
   4> if msgA-TransMax is applied and PREAMBLE_TRANSMISSION_COUNTER=msgA-TransMax+1:
      5> set the RA_TYPE to 4-stepRA;
      5> perform initialization of variables specific to Random Access type;
      5> if the Msg3 buffer is empty:
         6> obtain the MAC PDU to transmit from the MSGA buffer and store it in the Msg3 buffer;
      5> flush HARQ buffer used for the transmission of MAC PDU in the MSGA buffer;
      5> discard explicitly signalled contention-free 2-step RA type Random Access Resources, if any;
      5> perform the Random Access Resource selection procedure.
   4> else:
      5> perform the Random Access Resource selection procedure for 2-step RA type.

NOTE: The MSGA transmission includes the transmission of the PRACH Preamble as well as the contents of the MSGA buffer in the PUSCH resource corresponding to the selected PRACH occasion and PREAMBLE_INDEX (as specified in the 3GPP TS 38.213).

The MSGB-RNTI associated with the PRACH occasion in which the Random Access Preamble is transmitted, is computed as:

MSGB-RNTI=1+s_id+14×t_id+14×80×f_id+14×80×8×ul_carrier_id+14×80×8×2, where s_id is the index of the first OFDM symbol of the PRACH occasion (0≤s_id<14), t_id is the index of the first slot of the PRACH occasion in a system frame (0≤t_id<80), where the subcarrier spacing to determine t_id is based on the value of specified in in the 3GPP TS 38.211, f_id is the index of the PRACH occasion in the frequency domain (0≤f_id<8), and ul_carrier_id is the UL carrier used for Random Access Preamble transmission (0 for NUL carrier, and 1 for SUL carrier). The RA-RNTI is calculated as specified in the 3GPP TS 38.321.

RA Response Reception

Once the Random Access Preamble is transmitted and regardless of the possible occurrence of a measurement gap, the MAC entity shall:

1> if the contention-free Random Access Preamble for beam failure recovery request was transmitted by the MAC entity:

2> start the ra-ResponseWindow configured in BeamFailureRecoveryConfig at the first PDCCH occasion as specified in the 3GPP TS 38.213 from the end of the Random Access Preamble transmission;

2> monitor for a PDCCH transmission on the search space indicated by recoverySearchSpaceId of the SpCell identified by the C-RNTI while ra-Response Window is running.

1> else:

2> start the ra-Response Window configured in RACH-ConfigCommon at the first PDCCH occasion as specified in the 3GPP TS 38.213 from the end of the Random Access Preamble transmission;

2> monitor the PDCCH of the SpCell for Random Access Response(s) identified by the RA-RNTI while the ra-ResponseWindow is running.

1> if notification of a reception of a PDCCH transmission on the search space indicated by recoverySearchSpaceId is received from lower layers on the Serving Cell where the preamble was transmitted; and
1> if PDCCH transmission is addressed to the C-RNTI; and
1> if the contention-free Random Access Preamble for beam failure recovery request was transmitted by the MAC entity:

2> consider the Random Access procedure successfully completed.

1> else if a valid (as specified in the 3GPP TS 38.213) downlink assignment has been received on the PDCCH for the RA-RNTI and the received TB is successfully decoded:

2> if the Random Access Response contains a MAC subPDU with Backoff Indicator:
3> set the PREAMBLE BACKOFF to value of the BI field of the MAC subPDU, multiplied with SCALING FACTOR BI.

2> else:
3> set the PREAMBLE BACKOFF to 0 ms.

2> if the Random Access Response contains a MAC subPDU with Random Access Preamble identifier corresponding to the transmitted PREAMBLE_INDEX:
3> consider this Random Access Response reception successful.

2> if the Random Access Response reception is considered successful:
3> if the Random Access Response includes a MAC subPDU with RAPID only:
   4> consider this Random Access procedure successfully completed;
   4> indicate the reception of an acknowledgement for SI request to upper layers.
3> else:
   4> apply the following actions for the Serving Cell where the Random Access Preamble was transmitted:
      5> process the received Timing Advance Command;
      5> indicate the preambleReceivedTargetPower and the amount of power ramping applied to the latest Random Access Preamble transmission to lower layers (e.g., (PREAMBLE_POWER_RAMPING_COUNTER−1)×PREAMBLE_POWER_RAMPING_STEP);
      5> if the Random Access procedure for an SCell is performed on uplink carrier where pusch-Config is not configured:
         6> ignore the received UL grant.
      5> else:
         6> process the received UL grant value and indicate it to the lower layers.
   4> if the Random Access Preamble was not selected by the MAC entity among the contention-based Random Access Preamble(s):
      5> consider the Random Access procedure successfully completed.
   4> else:
      5> set the TEMPORARY C-RNTI to the value received in the Random Access Response;
      5> if this is the first successfully received Random Access Response within this Random Access procedure:
         6> if the transmission is not being made for the CCCH logical channel:
         7> indicate to the Multiplexing and assembly entity to include a C-RNTI MAC CE in the subsequent uplink transmission.
         6> if the Random Access procedure was initiated for SpCell beam failure recovery:
         7> indicate to the Multiplexing and assembly entity to include a BFR MAC CE or a Truncated BFR MAC CE in the subsequent uplink transmission.
         6> obtain the MAC PDU to transmit from the Multiplexing and assembly entity and store it in the Msg3 buffer.

NOTE: If within a Random Access procedure, an uplink grant provided in the Random Access Response for the same group of contention-based Random Access Preambles has a different size than the first uplink grant allocated during that Random Access procedure, the UE behavior is not defined.

1> if ra-ResponseWindow configured in BeamFailureRecoveryConfig expires and if a PDCCH transmission on the search space indicated by recoverySearchSpaceId addressed to the C-RNTI has not been received on the Serving Cell where the preamble was transmitted; or
1> if ra-ResponseWindow configured in RACH-ConfigCommon expires, and if the Random Access Response containing Random Access Preamble identifiers that matches the transmitted PREAMBLE_INDEX has not been received:

2> consider the Random Access Response reception not successful;

2> increment PREAMBLE_TRANSMISSION_COUNTER by 1;

2> if PREAMBLE_TRANSMISSION_COUNTER=preambleTransMax+1:
3> if the Random Access Preamble is transmitted on the SpCell:
   4> indicate a Random Access problem to upper layers;
   4> if this Random Access procedure was triggered for SI request:
      5> consider the Random Access procedure unsuccessfully completed.
3> else if the Random Access Preamble is transmitted on an SCell:
   4> consider the Random Access procedure unsuccessfully completed.

2> if the Random Access procedure is not completed:
3> select a random backoff time according to a uniform distribution between 0 and the PREAMBLE BACKOFF;
3> if the criteria to select contention-free Random Access Resources is met during the backoff time:
   4> perform the Random Access Resource selection procedure;
3> else if the Random Access procedure for an SCell is performed on uplink carrier where pusch-Config is not configured:
   4> delay the subsequent Random Access transmission until the Random Access Procedure is triggered by a PDCCH order with the same ra-PreambleIndex, ra-ssb-OccasionMaskIndex, and UL/SUL indicator in the 3GPP TS 38.212.
3> else:
   4> perform the Random Access Resource selection procedure after the backoff time.

The MAC entity may stop ra-Response Window (and hence monitoring for Random Access Response(s)) after successful reception of a Random Access Response containing Random Access Preamble identifiers that matches the transmitted PREAMBLE_INDEX.

HARQ operation is not applicable to the Random Access Response reception.

MSGB Reception and Contention Resolution for 2-Step RA Type

Once the MSGA preamble is transmitted, regardless of the possible occurrence of a measurement gap, the MAC entity shall:

1> start the msgB-ResponseWindow at the PDCCH occasion as specified in the 3GPP TS 38.213;
1> monitor the PDCCH of the SpCell for a Random Access Response identified by MSGB-RNTI while the msgB-ResponseWindow is running;
1> if C-RNTI MAC CE was included in the MSGA:

2> monitor the PDCCH of the SpCell for Random Access Response identified by the C-RNTI while the msgB-ResponseWindow is running.

1> if notification of a reception of a PDCCH transmission of the SpCell is received from lower layers:

2> if the C-RNTI MAC CE was included in MSGA:
3> if the Random Access procedure was initiated for SpCell beam failure recovery and the PDCCH transmission is addressed to the C-RNTI:
   4> consider this Random Access Response reception successful;
   4> stop the msgB-Response Window;
   4> consider this Random Access procedure successfully completed.
3> else if the timeAlignmentTimer associated with the PTAG is running:
   4> if the PDCCH transmission is addressed to the C-RNTI and contains a UL grant for a new transmission:
      5> consider this Random Access Response reception successful;
      5> stop the msgB-Response Window;
      5> consider this Random Access procedure successfully completed.
3> else:
   4> if a downlink assignment has been received on the PDCCH for the C-RNTI and the received TB is successfully decoded:
      5> if the MAC PDU contains the Absolute Timing Advance Command MAC CE subPDU:
         6> process the received Timing Advance Command;
         6> consider this Random Access Response reception successful;
         6> stop the msgB-Response Window;
         6> consider this Random Access procedure successfully completed and finish the disassembly and demultiplexing of the MAC PDU.

2> if a valid (as specified in the 3GPP TS 38.213) downlink assignment has been received on the PDCCH for the MSGB-RNTI and the received TB is successfully decoded:
3> if the MSGB contains a MAC subPDU with Backoff Indicator:
   4> set the PREAMBLE BACKOFF to value of the BI field of the MAC subPDU, multiplied with SCALING FACTOR BI.
3> else:
   4> set the PREAMBLE BACKOFF to 0 ms.
3> if the MSGB contains a fallbackRAR MAC subPDU; and
3> if the Random Access Preamble identifier in the MAC subPDU matches the transmitted PREAMBLE_INDEX:
   4> consider this Random Access Response reception successful;
   4> apply the following actions for the SpCell:
      5> process the received Timing Advance Command;
      5> indicate the msgA-PreambleReceivedTargetPower and the amount of power ramping applied to the latest Random Access Preamble transmission to lower layers (e.g., (PREAMBLE_POWER_RAMPING_COUNTER−1)×PREAMBLE_POWER_RAMPING_STEP);
      5> if the Random Access Preamble was not selected by the MAC entity among the contention-based Random Access Preamble(s):
         6> consider the Random Access procedure successfully completed;
         6> process the received UL grant value and indicate it to the lower layers.
      5> else:
         6> set the TEMPORARY C-RNTI to the value received in the Random Access Response;
         6> if the Msg3 buffer is empty:
         7> obtain the MAC PDU to transmit from the MSGA buffer and store it in the Msg3 buffer;
         6> process the received UL grant value and indicate it to the lower layers and proceed with Msg3 transmission.

NOTE: If within a 2-step RA type procedure, an uplink grant provided in the fallback RAR has a different size than the MSGA payload, the UE behavior is not defined.
3> else if the MSGB contains a successRAR MAC subPDU; and
3> if the CCCH SDU was included in the MSGA and the UE Contention Resolution Identity in the MAC subPDU matches the CCCH SDU:
   4> stop msgB-ResponseWindow;
   4> if this Random Access procedure was initiated for SI request:
      5> indicate the reception of an acknowledgement for SI request to upper layers.
   4> else:
      5> set the C-RNTI to the value received in the successRAR;
      5> apply the following actions for the SpCell:
         6> process the received Timing Advance Command;
         6> indicate the msgA-PreambleReceivedTargetPower and the amount of power ramping applied to the latest Random Access Preamble transmission to lower layers (e.g., (PREAMBLE_POWER_RAMPING_COUNTER−1)×PREAMBLE_POWER_RAMPING_STEP).
   4> deliver the TPC, PUCCH resource Indicator, ChannelAccess-CPext (if indicated), and HARQ feedback Timing Indicator received in successRAR to lower layers.
   4> consider this Random Access Response reception successful;
   4> consider this Random Access procedure successfully completed;
   4> finish the disassembly and demultiplexing of the MAC PDU.
      1> if msgB-ResponseWindow expires, and the Random Access Response Reception has not been considered as successful based on descriptions above:

2> increment PREAMBLE_TRANSMISSION_COUNTER by 1;

2> if PREAMBLE_TRANSMISSION_COUNTER=preamble TransMax+1:
3> indicate a Random Access problem to upper layers;
3> if this Random Access procedure was triggered for SI request:
   4> consider this Random Access procedure unsuccessfully completed.

2> if the Random Access procedure is not completed:
3> if msgA-TransMax is applied (see clause 5.1.1a) and PREAMBLE_TRANSMISSION_COUNTER=msgA-TransMax+1:
   4> set the RA_TYPE to 4-stepRA;
   4> perform initialization of variables specific to Random Access type;
   4> if the Msg3 buffer is empty:
      5> obtain the MAC PDU to transmit from the MSGA buffer and store it in the Msg3 buffer;
   4> flush HARQ buffer used for the transmission of MAC PDU in the MSGA buffer;
   4> discard explicitly signalled contention-free 2-step RA type Random Access Resources, if any;
   4> perform the Random Access Resource selection procedure.
3> else:
   4> select a random backoff time according to a uniform distribution between 0 and the PREAMBLE BACKOFF;
   4> if the criteria to select contention-free Random Access Resources is met during the backoff time:
      5> perform the Random Access Resource selection procedure for 2-step RA type Random Access.
   4> else:
      5> perform the Random Access Resource selection procedure for 2-step RA type Random Access after the backoff time.

Upon receiving a fallbackRAR, the MAC entity may stop msgB-Response Window once the Random Access Response reception is considered as successful.

Contention Resolution

Once Msg3 is transmitted the MAC entity shall:

1> start the ra-ContentionResolutionTimer and restart the ra-ContentionResolutionTimer at each HARQ retransmission in the first symbol after the end of the Msg3 transmission;
1> monitor the PDCCH while the ra-ContentionResolutionTimer is running regardless of the possible occurrence of a measurement gap;
1> if notification of a reception of a PDCCH transmission of the SpCell is received from lower layers:

2> if the C-RNTI MAC CE was included in Msg3:
3> if the Random Access procedure was initiated for SpCell beam failure recovery and the PDCCH transmission is addressed to the C-RNTI; or
3> if the Random Access procedure was initiated by a PDCCH order and the PDCCH transmission is addressed to the C-RNTI; or
3> if the Random Access procedure was initiated by the MAC sublayer itself or by the RRC sublayer and the PDCCH transmission is addressed to the C-RNTI and contains a UL grant for a new transmission:
   4> consider this Contention Resolution successful;
   4> stop ra-ContentionResolutionTimer;
   4> discard the TEMPORARY C-RNTI;
   4> consider this Random Access procedure successfully completed.

2> else if the CCCH SDU was included in Msg3 and the PDCCH transmission is addressed to its TEMPORARY C-RNTI:
3> if the MAC PDU is successfully decoded:
   4> stop ra-ContentionResolutionTimer;
   4> if the MAC PDU contains a UE Contention Resolution Identity MAC CE; and
   4> if the UE Contention Resolution Identity in the MAC CE matches the CCCH SDU transmitted in Msg3:
      5> consider this Contention Resolution successful and finish the disassembly and demultiplexing of the MAC PDU;
      5> if this Random Access procedure was initiated for SI request:
         6> indicate the reception of an acknowledgement for SI request to upper layers.
      5> else:
         6> set the C-RNTI to the value of the TEMPORARY C-RNTI;
      5> discard the TEMPORARY C-RNTI;
      5> consider this Random Access procedure successfully completed.
   4> else:
      5> discard the TEMPORARY C-RNTI;
      5> consider this Contention Resolution not successful and discard the successfully decoded MAC PDU.
         1> if ra-ContentionResolutionTimer expires:

2> discard the TEMPORARY C-RNTI;

2> consider the Contention Resolution not successful.

1> if the Contention Resolution is considered not successful:

2> flush the HARQ buffer used for transmission of the MAC PDU in the Msg3 buffer;

2> increment PREAMBLE_TRANSMISSION_COUNTER by 1;

2> if PREAMBLE_TRANSMISSION_COUNTER=preamble TransMax+1:
3> indicate a Random Access problem to upper layers.
3> if this Random Access procedure was triggered for SI request:
   4> consider the Random Access procedure unsuccessfully completed.

2> if the Random Access procedure is not completed:
3> if the RA_TYPE is set to 4-stepRA:
   4> select a random backoff time according to a uniform distribution between 0 and the PREAMBLE BACKOFF;
   4> if the criteria to select contention-free Random Access Resources is met during the backoff time:
      5> perform the Random Access Resource selection procedure;
   4> else:
      5> perform the Random Access Resource selection procedure after the backoff time.
3> else (e.g., the RA_TYPE is set to 2-stepRA):
   4> if msgA-TransMax is applied and PREAMBLE_TRANSMISSION_COUNTER=msgA-TransMax+1:
      5> set the RA_TYPE to 4-stepRA;
      5> perform initialization of variables specific to Random Access type;
      5> flush HARQ buffer used for the transmission of MAC PDU in the MSGA buffer;
      5> discard explicitly signalled contention-free 2-step RA type Random Access Resources, if any;
      5> perform the Random Access Resource selection.
   4> else:
      5> select a random backoff time according to a uniform distribution between 0 and the PREAMBLE BACKOFF;
      5> if the criteria to select contention-free Random Access Resources is met during the backoff time:
         6> perform the Random Access Resource selection procedure for 2-step RA type.
      5> else:
         6> perform the Random Access Resource selection for 2-step RA type procedure after the backoff time.

Completion of the RA Procedure

Upon completion of the Random Access procedure, the MAC entity shall:

1> discard any explicitly signalled contention-free Random Access Resources for 2-step RA type and 4-step RA type except the 4-step RA type contention-free Random Access Resources for beam failure recovery request, if any;
1> flush the HARQ buffer used for transmission of the MAC PDU in the Msg3 buffer and the MSGA buffer.

Upon successful completion of the Random Access procedure initiated for DAPS handover, the target MAC entity shall:

1> indicate the successful completion of the Random Access procedure to the upper layers.

Beam Failure Detection and Recovery Procedure

The MAC entity may be configured by RRC per Serving Cell with a beam failure recovery procedure which is used for indicating to the serving gNB of a new SSB or CSI-RS when beam failure is detected on the serving SSB(s)/CSI-RS(s). Beam failure is detected by counting beam failure instance indication from the lower layers to the MAC entity. If beamFailureRecoveryConfig is reconfigured by upper layers during an ongoing Random Access procedure for beam failure recovery for SpCell, the MAC entity shall stop the ongoing Random Access procedure and initiate a Random Access procedure using the new configuration.

RRC configures the following parameters in the BeamFailureRecoveryConfig and the RadioLinkMonitoringConfig for the Beam Failure Detection and Recovery procedure:
beamFailureInstanceMaxCount for the beam failure detection;
beamFailureDetectionTimer for the beam failure detection;
beamFailureRecovery Timer for the beam failure recovery procedure;
rsrp-ThresholdSSB: an RSRP threshold for the beam failure recovery;
powerRampingStep: powerRampingStep for the SpCell beam failure recovery;
powerRampingStepHighPriority: powerRampingStepHighPriority for the SpCell beam failure recovery;
preambleReceivedTargetPower: preambleReceivedTargetPower for the SpCell beam failure recovery;
preambleTransMax: preamble TransMax for the SpCell beam failure recovery;
scalingFactorBL: scalingFactorBI for the SpCell beam failure recovery;
ssb-perRACH-Occasion: ssb-perRACH-Occasion for the SpCell beam failure recovery;
ra-ResponseWindow: the time window to monitor response(s) for the SpCell beam failure recovery using contention-free Random Access Preamble;
prach-ConfigurationIndex: prach-ConfigurationIndex for the SpCell beam failure recovery;
ra-ssb-OccasionMaskIndex: ra-ssb-OccasionMaskIndex for the SpCell beam failure recovery; and
ra-OccasionList: ra-OccasionList for the SpCell beam failure recovery.

The following UE variables are used for the beam failure detection procedure:
BFI COUNTER (per Serving Cell): counter for beam failure instance indication which is initially set to 0.

The MAC entity shall for each Serving Cell configured for beam failure detection:

1> if beam failure instance indication has been received from lower layers:

2> start or restart the beamFailureDetectionTimer;

2> increment BFI COUNTER by 1;

2> if BFI COUNTER>=beamFailureInstanceMaxCount:
3> if the Serving Cell is SCell:
   4> trigger a BFR for this Serving Cell;
3> else:
   4> initiate a Random Access procedure on the SpCell.
      1> if the beamFailureDetectionTimer expires; or
      1> if beamFailureDetectionTimer, beamFailureInstanceMaxCount, or any of the reference signals used for beam failure detection is reconfigured by upper layers associated with this Serving Cell:

2> set BFI COUNTER to 0.

1> if the Serving Cell is SpCell and the Random Access procedure initiated for SpCell beam failure recovery is successfully completed:

2> set BFI COUNTER to 0;

2> stop the beamFailureRecovery Timer, if configured;

2> consider the Beam Failure Recovery procedure successfully completed.

1> else if the Serving Cell is SCell, and a PDCCH addressed to C-RNTI indicating uplink grant for a new transmission is received for the HARQ process used for the transmission of the BFR MAC CE or Truncated BFR MAC CE which contains beam failure recovery information of this Serving Cell; or
1> if the SCell is deactivated:

2> set BFI COUNTER to 0;

2> consider the Beam Failure Recovery procedure successfully completed and cancel all the triggered BFRs for this Serving Cell.

The MAC entity shall:

1> if the Beam Failure Recovery procedure determines that at least one BFR has been triggered and not cancelled:

2> if UL-SCH resources are available for a new transmission and if the UL-SCH resources can accommodate the BFR MAC CE plus its subheader as a result of Logical Channel Prioritization (LCP):
3> instruct the Multiplexing and Assembly procedure to generate the BFR MAC CE.

2> else if UL-SCH resources are available for a new transmission and if the UL-SCH resources can accommodate the Truncated BFR MAC CE plus its subheader as a result of LCP:
3> instruct the Multiplexing and Assembly procedure to generate the Truncated BFR MAC CE.

2> else:
3> trigger the SR for SCell beam failure recovery for each SCell for which BFR has been triggered and not cancelled.

All BFRs triggered prior to MAC PDU assembly for beam failure recovery for an SCell shall be cancelled when a MAC PDU is transmitted and this PDU includes a BFR MAC CE or Truncated BFR MAC CE which contains beam failure information of that SCell.

Activation/Deactivation of UE-Specific PDSCH TCI State

The network may activate and deactivate the configured TCI states for PDSCH of a Serving Cell or a set of Serving Cells configured in simultaneousTCI-UpdateList1-r16 or simultaneousTCI-UpdateList2-r16 by sending the TCI States Activation/Deactivation for UE-specific PDSCH MAC CE. The network may activate and deactivate the configured TCI states for a codepoint of the DCI Transmission configuration indication field as specified in the 3GPP TS 38.212 for PDSCH of a Serving Cell by sending the Enhanced TCI States Activation/Deactivation for UE-specific PDSCH MAC CE. The configured TCI states for PDSCH are initially deactivated upon configuration and after a handover.

The MAC entity shall:

1> if the MAC entity receives a TCI States Activation/Deactivation for UE-specific PDSCH MAC CE on a Serving Cell:

2> indicate to lower layers the information regarding the TCI States Activation/Deactivation for UE-specific PDSCH MAC CE.

1> if the MAC entity receives an Enhanced TCI States Activation/Deactivation for UE-specific PDSCH MAC CE on a Serving Cell:

2> indicate to lower layers the information regarding the Enhanced TCI States Activation/Deactivation for UE-specific PDSCH MAC CE.

Indication of TC State for UE-Specific PDCCH

The network may indicate a TCI state for PDCCH reception for a CORESET of a Serving Cell or a set of Serving Cells configured in simultaneousTCI-UpdateList1-r16 or simultaneousTCI-UpdateList2-r16 by sending the TCI State Indication for UE-specific PDCCH MAC CE.

The MAC entity shall:

1> if the MAC entity receives a TCI State Indication for UE-specific PDCCH MAC CE on a Serving Cell:

2> indicate to lower layers the information regarding the TCI State Indication for UE-specific PDCCH MAC CE.

Activation/Deactivation of Spatial Relation of PUCCH Resource

The network may activate and deactivate a spatial relation for a PUCCH resource of a Serving Cell by sending the PUCCH spatial relation Activation/Deactivation MAC CE. The network may also activate and deactivate a spatial relation for a PUCCH resource or a PUCCH resource group of a Serving Cell by sending the Enhanced PUCCH spatial relation Activation/Deactivation MAC CE.

The MAC entity shall:

1> if the MAC entity receives a PUCCH spatial relation Activation/Deactivation MAC CE on a Serving Cell:

2> indicate to lower layers the information regarding the PUCCH spatial relation Activation/Deactivation MAC CE.

1> if the MAC entity receives an Enhanced PUCCH spatial relation Activation/Deactivation MAC CE on a Serving Cell:

2> indicate to lower layers the information regarding the Enhanced PUCCH spatial relation Activation/Deactivation MAC CE.

TCI States Activation/Deactivation for UE-Specific PDSCH MAC CE

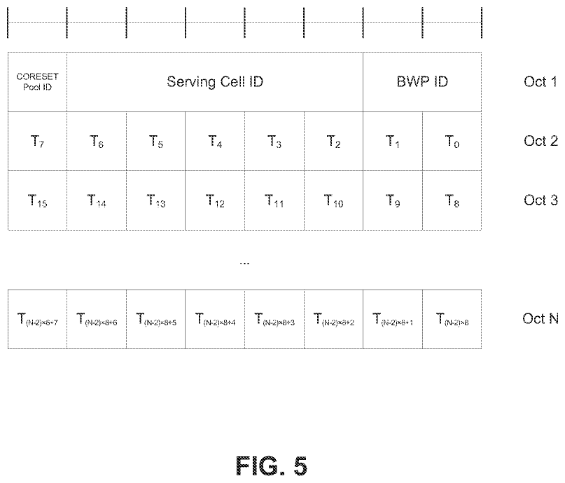

The TCI states activation/deactivation for UE-specific PDSCH MAC CE is identified by a MAC subheader with logical channel identifier (LCID). FIG. 5 is a schematic diagram illustrating a Transmission Configuration Indicator (TCI) states activation/deactivation, according to an implementation of the present disclosure. It has a variable size consisting of following fields:
Serving Cell ID: This field indicates the identity of the Serving Cell for which the MAC CE applies. The length of the field is 5 bits. If the indicated Serving Cell is configured as part of a simultaneousTCI-UpdateList1-r16 or simultaneousTCI-UpdateList2-r16 as specified in the 3GPP TS 38.331, this MAC CE applies to all the Serving Cells configured in the set simultaneousTCI-UpdateList1-r16 or simultaneousTCI-UpdateList2-r16, respectively;
BWP ID: This field indicates a DL BWP to which the MAC CE applies as the codepoint of the DCI bandwidth part indicator field as specified in the 3GPP TS 38.212. The length of the BWP ID field is 2 bits. This field is ignored if this MAC CE applies to a set of Serving Cells;
Tᵢ: If there is a TCI state with TCI-StateId i as specified in the 3GPP TS 38.331, this field indicates the activation/deactivation status of the TCI state with TCI-StateId i, otherwise MAC entity shall ignore the Tᵢ field. The Tᵢ field is set to 1 to indicate that the TCI state with TCI-StateId i shall be activated and mapped to the codepoint of the DCI Transmission Configuration Indication field, as specified in the 3GPP TS 38.214. The Tᵢ field is set to 0 to indicate that the TCI state with TCI-StateId i shall be deactivated and is not mapped to the codepoint of the DCI Transmission Configuration Indication field. The codepoint to which the TCI State is mapped is determined by its ordinal position among all the TCI States with Tᵢ field set to 1 (e.g., the first TCI State with Tᵢ field set to 1 shall be mapped to the codepoint value 0, second TCI State with Tᵢ field set to 1 shall be mapped to the codepoint value 1 and so on). The maximum number of activated TCI states is 8; and
CORESET Pool ID: This field indicates that mapping between the activated TCI states and the codepoint of the DCI Transmission Configuration Indication set by field Tᵢ is specific to the ControlResourceSetId configured with CORESET Pool ID as specified in the 3GPP TS 38.331. This field set to 1 indicates that this MAC CE shall be applied for the DL transmission scheduled by CORESET with the CORESET pool ID equal to 1, otherwise, this MAC CE shall be applied for the DL transmission scheduled by CORESET pool ID equal to 0. If the coresetPoolIndex is not configured for any CORESET, MAC entity shall ignore the CORESET Pool ID field in this MAC CE when receiving the MAC CE. If the Serving Cell in the MAC CE is configured in a cell list that contains more than one Serving Cell, the CORSET Pool ID field shall be ignored when receiving the MAC CE.

TCI State Indication for UE-Specific PDCCH MAC CE

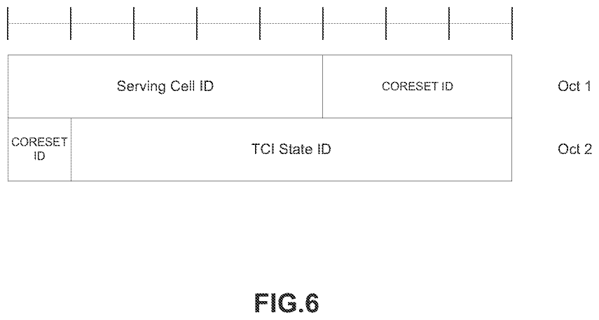

The TCI state indication for UE-specific PDCCH MAC CE is identified by a MAC subheader with LCID. FIG. 6 is a schematic diagram illustrating a TCI state indication, according to an implementation of the present disclosure. It has a fixed size of 16 bits with following fields:
Serving Cell ID: This field indicates the identity of the Serving Cell to which the MAC CE applies. The length of the field is 5 bits. If the indicated Serving Cell is configured as part of a simultaneousTCI-UpdateList1-r16 or simultaneousTCI-UpdateList2-r16 as specified in the 3GPP TS 38.331, this MAC CE applies to all the Serving Cells in the set simultaneousTCI-UpdateList1-r16 or simultaneousTCI-UpdateList2-r16, respectively;
CORESET ID: This field indicates a Control Resource Set identified with ControlResourceSetId as specified in the 3GPP TS 38.331, for which the TCI State is indicated. In case the value of the field is 0, the field refers to the Control Resource Set configured by controlResourceSetZero as specified in the 3GPP TS 38.331. The length of the field is 4 bits; and
TCI State ID: This field indicates the TCI state identified by TCI-StateId as specified in the 3GPP TS 38.331 applicable to the Control Resource Set identified by CORESET ID field. If the CORESET ID field is set to 0, this field indicates a TCI-StateId for a TCI state of the first 64 TCI-states configured by tci-States-ToAddModList and tci-States-ToReleaseList in the PDSCH-Config in the active BWP. If the CORESET ID field is set to a value other than 0, this field indicates a TCI-StateId configured by tci-StatesPDCCH-ToAddList and tci-StatesPDCCH-ToReleaseList in the controlResourceSet identified by the indicated CORESET ID. The length of the field is 7 bits.

PUCCH Spatial Relation Activation/Deactivation MAC CE

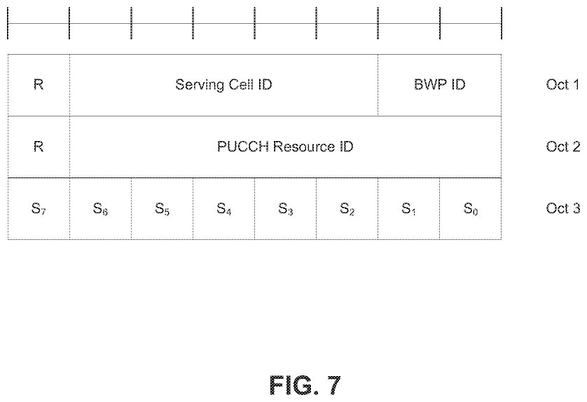

The PUCCH spatial relation Activation/Deactivation MAC CE is identified by a MAC subheader with LCID. FIG. 7 is a schematic diagram illustrating a PUCCH spatial relation activation/deactivation MAC CE, according to an implementation of the present disclosure. It has a fixed size of 24 bits with following fields:
Serving Cell ID: This field indicates the identity of the Serving Cell to which the MAC CE applies. The length of the field is 5 bits;
BWP ID: This field indicates a UL BWP to which the MAC CE applies as the codepoint of the DCI bandwidth part indicator field as specified in the 3GPP TS 38.212. The length of the BWP ID field is 2 bits;
PUCCH Resource ID: This field contains an identifier of the PUCCH resource ID identified by PUCCH-ResourceId as specified in the 3GPP TS 38.331. The length of the field is 7 bits;
Sᵢ: If, in PUCCH-Config in which the PUCCH Resource ID is configured, there is PUCCH Spatial Relation Info with PUCCH-SpatialRelationInfold as specified in the 3GPP TS 38.331, configured for the uplink bandwidth part indicated by the BWP ID field, Sᵢ indicates the activation status of PUCCH Spatial Relation Info with PUCCH-SpatialRelationInfold equal to i+1, otherwise the MAC entity shall ignore this field. The Sᵢ field is set to 1 to indicate that PUCCH Spatial Relation Info with PUCCH-SpatialRelationInfold equal to i+1 shall be activated. The Sᵢ field is set to 0 to indicate that PUCCH Spatial Relation Info with PUCCH-SpatialRelationInfold equal to i+1 shall be deactivated. Only a single PUCCH Spatial Relation Info can be active for a PUCCH Resource at a time; and
R: Reserved bit, set to 0.

BFR MAC CEs

The MAC CEs for BFR consist of either:
a BFR MAC CE; or
a Truncated BFR MAC CE.

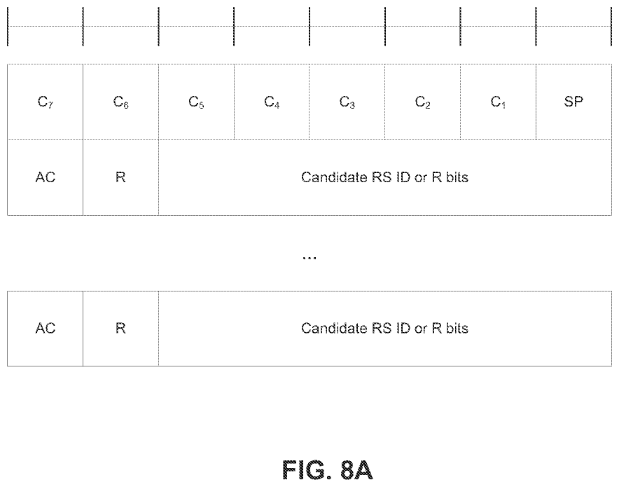

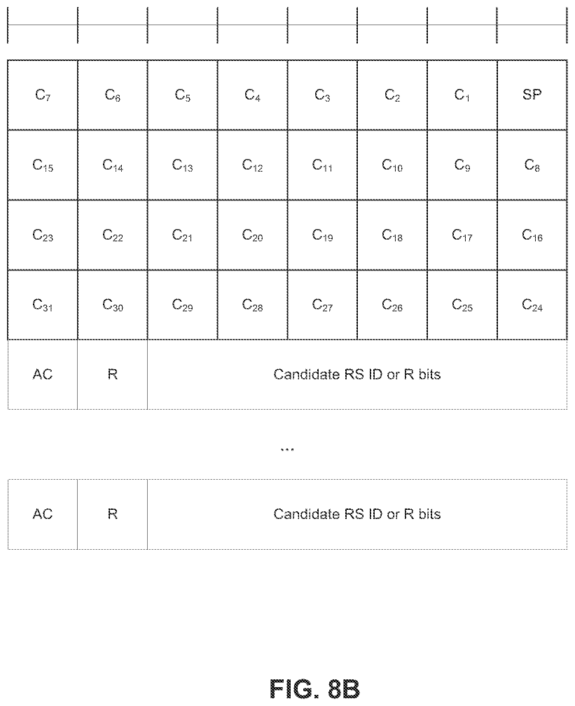

The BFR MAC CE and Truncated BFR MAC CE are identified by a MAC subheader with LCID/extended LCID (eLCID). FIG. 8A is a schematic diagram illustrating a SCell BFR and Truncated SCell BFR MAC CE, according to an implementation of the present disclosure. FIG. 8B is a schematic diagram illustrating a Secondary Cell (SCell) Beam Failure Recovery (BFR) and a truncated SCell BFR MAC CE, according to another implementation of the present disclosure. In FIG. 8A, a SCell BFR and Truncated SCell BFR MAC CE with the highest ServCellIndex of the MAC entity's SCell configured with BFD is less than 8. In FIG. 8B, the SCell BFR and Truncated SCell BFR MAC CE with the highest ServCellIndex of the MAC entity's SCell configured with BFD is equal to or greater than 8.

The BFR MAC CE and Truncated BFR MAC CE have a variable size. They include a bitmap and in ascending order based on the ServCellIndex, beam failure recovery information (e.g., octets containing candidate beam availability indication (AC) for SCells indicated in the bitmap). For the BFR MAC CE, a single octet bitmap is used when the highest ServCellIndex of the MAC entity's SCell for which beam failure is detected is less than 8, otherwise four octets are used. A MAC PDU shall contain at most one BFR MAC CE.

For a Truncated BFR MAC CE, a single octet bitmap is used for the following cases, otherwise four octets are used:
the highest ServCellIndex of the MAC entity's SCell for which beam failure is detected is less than 8; or
beam failure is detected for the SpCell and the SpCell is to be indicated in a Truncated BFR MAC CE and the UL-SCH resources available for transmission cannot accommodate the Truncated BFR MAC CE with the four octets bitmap plus its subheader as a result of LCP.

The fields in the BFR MAC CEs are defined as follows:
SP: This field indicates beam failure detection for the SpCell of this MAC entity. The SP field is set to 1 to indicate that beam failure is detected for SpCell only when BFR MAC CE or Truncated BFR MAC CE is to be included into a MAC PDU as part of Random Access Procedure, otherwise, it is set to 0;
Cᵢ (BFR MAC CE): This field indicates beam failure detection and the presence of an octet containing the AC field for the SCell with ServCellIndex i as specified in the 3GPP TS 38.331. The Cᵢ field set to 1 indicates that beam failure is detected and the octet containing the AC field is present for the SCell with ServCellIndex i. The Cᵢ field set to 0 indicates that the beam failure is not detected and octet containing the AC field is not present for the SCell with ServCellIndex i. The octets containing the AC field are present in ascending order based on the ServCellIndex;
Cᵢ (Truncated BFR MAC CE): This field indicates beam failure detection for the SCell with ServCellIndex i as specified in the 3GPP TS 38.331. The Cᵢ field set to 1 indicates that beam failure is detected and the octet containing the AC field for the SCell with ServCellIndex i may be present. The Cᵢ field set to 0 indicates that the beam failure is not detected and the octet containing the AC field is not present for the SCell with ServCellIndex i. The octets containing the AC field, if present, are included in ascending order based on the ServCellIndex. The number of octets containing the AC field included is maximised, while not exceeding the available grant size;

NOTE: The number of the octets containing the AC field in the Truncated BFR MAC CE can be zero.
AC: This field indicates the presence of the Candidate RS ID field in this octet. If at least one of the SSBs with SS-RSRP above rsrp-ThresholdBFR among the SSBs in candidateBeamRSSCellList or the CSI-RSs with CSI-RSRP above rsrp-ThresholdBFR among the CSI-RSs in candidateBeamRSSCellList is available, the AC field is set to 1; otherwise, it is set to 0. If the AC field set to 1, the Candidate RS ID field is present. If the AC field set to 0, R bits are present instead;
Candidate RS ID: This field is set to the index of an SSB with SS-RSRP above rsrp-ThresholdBFR among the SSBs in candidateBeamRSSCellList or to the index of a CSI-RS with CSI-RSRP above rsrp-ThresholdBFR among the CSI-RSs in candidateBeamRSSCellList. The length of this field is 6 bits; and
R: Reserved bit, set to 0.

Enhanced PUCCH Spatial Relation Activation/Deactivation MAC CE

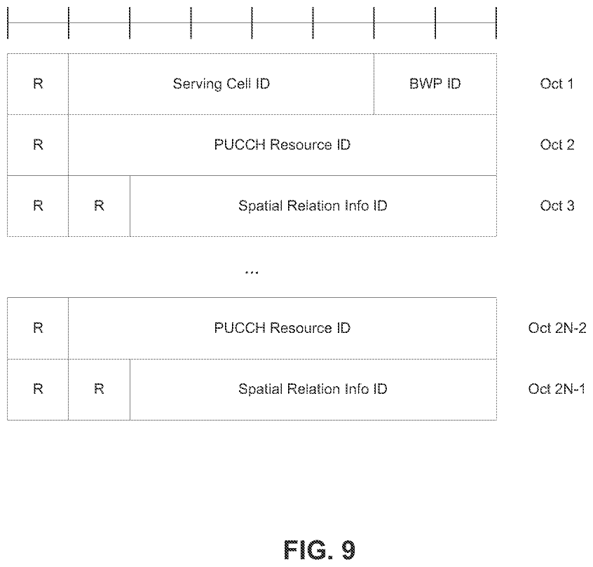

The enhanced PUCCH spatial relation activation/deactivation MAC CE is identified by a MAC subheader with eLCID. FIG. 9 is a schematic diagram illustrating an enhanced PUCCH spatial relation activation/deactivation MAC CE, according to an implementation of the present disclosure. It has a variable size with following fields:
Serving Cell ID: This field indicates the identity of the Serving Cell for which the MAC CE applies. The length of the field is 5 bits;
BWP ID: This field indicates a UL BWP for which the MAC CE applies as the codepoint of the DCI bandwidth part indicator field as specified in the 3GPP TS 38.212. The length of the BWP ID field is 2 bits;
PUCCH Resource ID: This field contains an identifier of the PUCCH resource ID identified by PUCCH-ResourceId as specified in the 3GPP TS 38.331. The length of the field is 7 bits. If the indicated PUCCH Resource is configured as part of a PUCCH Group as specified in the 3GPP TS 38.331, no other PUCCH Resources within the same PUCCH group are indicated in the MAC CE, and this MAC CE applies to all the PUCCH Resources in the PUCCH group;
Spatial Relation Info ID: This field contains an identifier of the PUCCH Spatial Relation Info ID identified by PUCCH-SpatialRelationInfold, in PUCCH-Config in which the PUCCH Resource ID is configured, as specified in the 3GPP TS 38.331. The length of the field is 6 bits; and
R: Reserved bit, set to 0.

UE States and State Transitions Including Inter RAT

A UE is either in RRC_CONNECTED state or in RRC_INACTIVE state when an RRC connection has been established. If this is not the case (e.g., no RRC connection is established), the UE is in RRC_IDLE state.

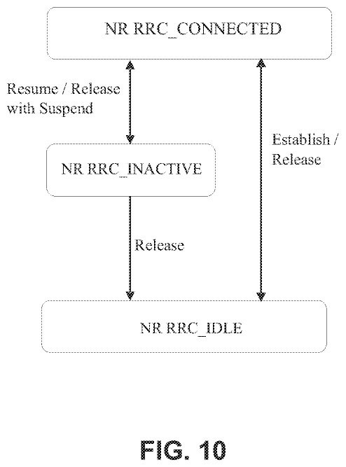

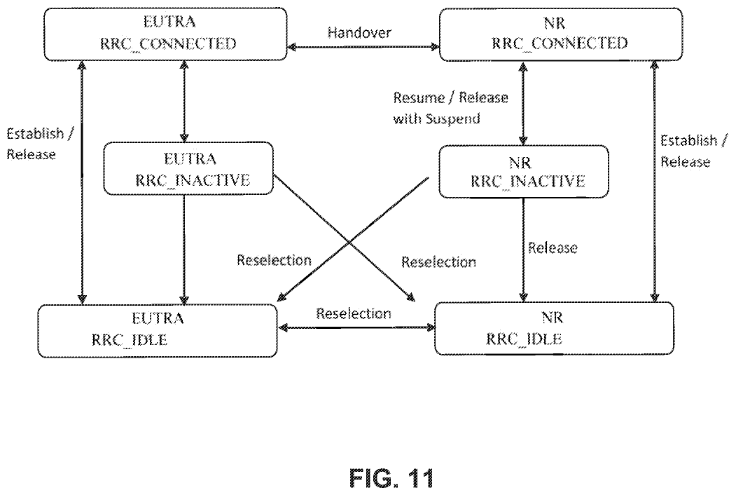

FIG. 10 is a schematic diagram illustrating an overview of UE RRC state machine and state transitions, according to an implementation of the present disclosure. The RRC states includes NR RRC_CONNECTED, NR RRC_INACTIVE and NR RRC_IDLE. As illustrated in FIG. 10, the UE has only one RRC state in NR at one time. On the other hand, FIG. 11 is a schematic diagram illustrating an overview of UE state machine and state transitions in NR as well as the mobility procedures supported between NR/5GC E-UTRA/EPC and E-UTRA/5GC, according to an implementation of the present disclosure.

BeamFailureRecoveryConfig

The information element (IE) BeamFailureRecoveryConfig is used to configure the UE with RACH resources and candidate beams for beam failure recovery in case of beam failure detection, as specified in the 3GPP TS 38.321. More details of BeamFailureRecoveryConfig IE are introduced in the following.

-- ASN1START
-- TAG-BEAMFAILURERECOVERYCONFIG-START

| | |
|---|---|
| BeamFailureRecoveryConfig ::= | SEQUENCE { |
| rootSequenceIndex-BFR | INTEGER (0..137) |
| OPTIONAL, -- Need M | |
| rach-ConfigBFR | RACH-ConfigGeneric |
| OPTIONAL, -- Need M | |
| rsrp-ThresholdSSB | RSRP-Range |
| OPTIONAL, -- Need M | |
| candidateBeamRSList | SEQUENCE (SIZE(1..maxNrofCandidateBeams)) OF PRACH- |

ResourceDedicatedBFR OPTIONAL, -- Need M

| | |
|---|---|
| ssb-perRACH-Occasion | ENUMERATED {oneEighth, oneFourth, oneHalf, one, two, |
| | four, eight, sixteen} |
| OPTIONAL, -- Need M | |
| ra-ssb-OccasionMaskIndex | INTEGER (0..15) |
| OPTIONAL, -- Need M | |
| recoverySearchSpaceId | SearchSpaceId |
| OPTIONAL, -- Need R | |
| ra-Prioritization | RA-Prioritization |
| OPTIONAL, -- Need R | |
| beamFailureRecoveryTimer | ENUMERATED {ms10, ms20, ms40, ms60, ms80, ms100, |

ms150, ms200} OPTIONAL, -- Need M

| | |
|---|---|
| . . . , | |
| [[ | |
| msg1-SubcarrierSpacing | SubcarrierSpacing |
| OPTIONAL -- Need M | |
| ]], | |
| [[ | |
| ra-PrioritizationTwoStep-r16 | RA-Prioritization |
| OPTIONAL, -- Need R | |
| candidateBeamRSListExt-v1610 | SetupRelease{ CandidateBeamRSListExt-r16 } |
| OPTIONAL -- Need M | |
| ]] | |
| } | |
| PRACH-ResourceDedicatedBFR ::= | CHOICE { |
| ssb | BFR-SSB-Resource, |
| csi-RS | BFR-CSIRS-Resource |
| } | |
| BFR-SSB-Resource ::= | SEQUENCE { |
| ssb | SSB-Index, |
| ra-PreambleIndex | INTEGER (0..63), |
| . . . | |
| } | |
| BFR-CSIRS-Resource ::= | SEQUENCE { |
| csi-RS | NZP-CSI-RS-ResourceId, |
| ra-OccasionList | SEQUENCE (SIZE(1..maxRA-OccasionsPerCSIRS)) OF INTEGER |

(0..maxRA-Occasions-1) OPTIONAL, -- Need R

| | |
|---|---|
| ra-PreambleIndex | INTEGER (0..63) |
| OPTIONAL, -- Need R | |
| . . . | |
| } | |
| CandidateBeamRSListExt-r16::= | SEQUENCE (SIZE(1.. maxNrofCandidateBeamsExt-r16)) OF |

PRACH-ResourceDedicatedBFR
-- TAG-BEAMFAILURERECOVERYCONFIG-STOP
-- ASN1STOP

BeamFailureRecoverySCellConfig

The IE BeamFailureRecoverySCellConfig is used to configure the UE with candidate beams for beam failure recovery in case of beam failure detection in SCell, as specified in the 3GPP TS 38.321. More details of BeamFailureRecoverySCellConfig IE are introduced in the following.

-- ASN1START
-- TAG-BEAMFAILURERECOVERYSCELLCONFIG-START

| | |
|---|---|
| BeamFailureRecoverySCellConfig-r16 ::= | SEQUENCE { |
| rsrp-ThresholdBFR-r16 | RSRP-Range |
| OPTIONAL, -- Need M | |
| candidateBeamRSSCellList-r16 | SEQUENCE (SIZE(1..maxNrofCandidateBeams-r16)) OF |

CandidateBeamRS-r16 OPTIONAL, -- Need M
. . .
}

| | |
|---|---|
| CandidateBeamRS-r16 ::= | SEQUENCE { |
| candidateBeamConfig-r16 | CHOICE { |
| ssb-r16 | SSB-Index, |
| csi-RS-r16 | NZP-CSI-RS-ResourceId |
| }, | |
| servingCellId | ServCellIndex |

OPTIONAL -- Need R
}
-- TAG-BEAMFAILURERECOVERYSCELLCONFIG-STOP
-- ASN1STOP

ControlResourceSet

The IE ControlResourceSet is used to configure a time/frequency control resource set (CORESET) in which to search for downlink control information (see the 3GPP TS 38.213). More details of ControlResourceSet IE are introduced in the following.

-- ASN1START
-- TAG-CONTROLRESOURCESET-START

| | |
|---|---|
| ControlResourceSet ::= | SEQUENCE { |
| controlResourceSetId | ControlResourceSetId, |
| frequencyDomainResources | BIT STRING (SIZE (45)), |
| duration | INTEGER (1..maxCoReSetDuration), |
| cce-REG-MappingType | CHOICE { |
| interleaved | SEQUENCE { |
| reg-BundleSize | ENUMERATED {n2, n3, n6}, |
| interleaverSize | ENUMERATED {n2, n3, n6}, |
| shiftIndex | INTEGER(0..maxNrofPhysicalResourceBlocks-1) |
| OPTIONAL -- Need S | |
| }, | |
| nonInterleaved | NULL |
| }, | |
| precoderGranularity | ENUMERATED {sameAsREG-bundle, allContiguousRBs}, |
| tci-StatesPDCCH-ToAddList | SEQUENCE(SIZE (1..maxNrofTCI-StatesPDCCH)) OF TCI- |

StateId OPTIONAL, -- Cond NotSIB1-initialBWP

| | |
|---|---|
| tci-StatesPDCCH-ToReleaseList | SEQUENCE(SIZE (1..maxNrofTCI-StatesPDCCH)) OF TCI- |

StateId OPTIONAL, -- Cond NotSIB1-initialBWP

| | |
|---|---|
| tci-PresentInDCI | ENUMERATED {enabled} |
| OPTIONAL, -- Need S | |
| pdcch-DMRS-ScramblingID | INTEGER (0..65535) |

```
OPTIONAL, -- Need S
    . . . ,
    [[
```

| | |
|---|---|
| rb-Offset-r16 | INTEGER (0..5) |
| OPTIONAL, -- Need S | |
| tci-PresentForDCI-Format1-2-r16 | INTEGER (1..3) |
| OPTIONAL, -- Need S | |
| coresetPoolIndex-r16 | INTEGER (0..1) |
| OPTIONAL, -- Need S | |
| controlResourceSetId-v1610 | ControlResourceSetId-v1610 |

OPTIONAL -- Need S
]]
}
-- TAG-CONTROLRESOURCESET-STOP
-- ASN1STOP

PUCCH-Config

The IE PUCCH-Config is used to configure UE specific PUCCH parameters (per BWP). More details of PUCCH-Config IE are introduced in the following.

-- ASN1START
-- TAG-PUCCH-CONFIG-START

| | |
|---|---|
| PUCCH-Config ::= | SEQUENCE { |

| | |
|---|---|
| resourceSetToAddModList | SEQUENCE (SIZE (1..maxNrofPUCCH-ResourceSets)) OF |
| PUCCH-ResourceSet OPTIONAL, -- Need N | |
| resourceSetToReleaseList | SEQUENCE (SIZE (1..maxNrofPUCCH-ResourceSets)) OF |
| PUCCH-ResourceSetId OPTIONAL, -- Need N | |
| resourceToAddModList | SEQUENCE (SIZE (1..maxNrofPUCCH-Resources)) OF |
| PUCCH-Resource OPTIONAL, -- Need N | |
| resourceToReleaseList | SEQUENCE (SIZE (1..maxNrofPUCCH-Resources)) OF |
| PUCCH-ResourceId OPTIONAL, -- Need N | |
| format1 | SetupRelease { PUCCH-FormatConfig } |
| OPTIONAL, -- Need M | |
| format2 | SetupRelease { PUCCH-FormatConfig } |
| OPTIONAL, -- Need M | |
| format3 | SetupRelease { PUCCH-FormatConfig } |
| OPTIONAL, -- Need M | |
| format4 | SetupRelease { PUCCH-FormatConfig } |
| OPTIONAL, -- Need M | |
| schedulingRequestResourceToAddModList | SEQUENCE (SIZE (1..maxNrofSR-Resources)) OF |
| SchedulingRequestResourceConfig | |
| OPTIONAL, -- Need N | |
| schedulingRequestResourceToReleaseList | SEQUENCE (SIZE (1..maxNrofSR-Resources)) OF |
| SchedulingRequestResourceId | |
| OPTIONAL, -- Need N | |
| multi-CSI-PUCCH-ResourceList | SEQUENCE (SIZE (1..2)) OF PUCCH-ResourceId |
| OPTIONAL, -- Need M | |
| dl-DataToUL-ACK | SEQUENCE (SIZE (1..8)) OF INTEGER (0..15) |
| OPTIONAL, -- Need M | |
| spatialRelationInfoToAddModList | SEQUENCE (SIZE (1..maxNrofSpatialRelationInfos)) |
| OF PUCCH-SpatialRelationInfo | |
| OPTIONAL, -- Need N | |
| spatialRelationInfoToReleaseList | SEQUENCE (SIZE (1..maxNrofSpatialRelationInfos)) |
| OF PUCCH-SpatialRelationInfoId | |
| OPTIONAL, -- Need N | |
| pucch-PowerControl | PUCCH-PowerControl |
| OPTIONAL, -- Need M | |
| . . . , | |
| [[ | |
| resourceToAddModListExt-r16 | SEQUENCE (SIZE (1..maxNrofPUCCH-Resources)) OF |
| PUCCH-ResourceExt-r16 OPTIONAL, -- Need N | |
| dl-DataToUL-ACK-r16 | SetupRelease { DL-DataToUL-ACK-r16 } |

OPTIONAL, -- Need M
ul-AccessConfigListForDCI-Format-1-1-r16 SetupRelease { UL-AccessConfigListForDCI-Format1-
1-r16 } OPTIONAL, -- Need M

| | |
|---|---|
| subslotLengthForPUCCH-r16 | CHOICE { |
| normalCP-r16 | ENUMERATED {n2,n7}, |
| extendedCP-r16 | ENUMERATED {n2,n6} |
| } | |
| OPTIONAL, -- Need R | |
| dl-DataToUL-ACK-ForDCI-Format1-2-r16 | SetupRelease { DL-DataToUL-ACK-ForDCI-Format1-2- |

r16} OPTIONAL, -- Need M
numberOfBitsForPUCCH-ResourceIndicatorForDCI-Format1-2-r16 INTEGER (0..3)
OPTIONAL, -- Need R

| | |
|---|---|
| dmrs-UplinkTransformPrecodingPUCCH-r16 | ENUMERATED {enabled} |
| OPTIONAL, -- Cond P12-BPSK | |
| spatialRelationInfoToAddModList2-r16 | SEQUENCE (SIZE |

(1..maxNrofSpatialRelationInfosDiff-r16)) OF PUCCH-SpatialRelationInfo
OPTIONAL, -- Need N

| | |
|---|---|
| spatialRelationInfoToReleaseList2-r16 | SEQUENCE (SIZE |

(1..maxNrofSpatialRelationInfosDiff-r16)) OF PUCCH-SpatialRelationInfoId
OPTIONAL, -- Need N

| | |
|---|---|
| spatialRelationInfoToAddModListExt-r16 | SEQUENCE (SIZE (1..maxNrofSpatialRelationInfos- |
| r16)) OF PUCCH-SpatialRelationInfoExt-r16 | |
| OPTIONAL, -- Need N | |
| spatialRelationInfoToReleaseList-r16 | SEQUENCE (SIZE (1..maxNrofSpatialRelationInfos- |
| r16)) OF PUCCH-SpatialRelationInfoId-r16 | OPTIONAL, -- Need N |
| resourceGroupToAddModList-r16 | SEQUENCE (SIZE (1..maxNrofPUCCH-ResourceGroups- |
| r16)) OF PUCCH-ResourceGroup-r16 | |
| OPTIONAL, -- Need N | |
| resourceGroupToReleaseList-r16 | SEQUENCE (SIZE (1..maxNrofPUCCH-ResourceGroups- |
| r16)) OF PUCCH-ResourceGroupId-r16 | |
| OPTIONAL, -- Need N | |
| sps-PUCCH-AN-List-r16 | SetupRelease { SPS-PUCCH-AN-List-r16 } |
| OPTIONAL, -- Need M | |

schedulingRequestResourceToAddModList-v1610 SEQUENCE (SIZE (1..maxNrofSR-Resources)) OF

SchedulingRequestResourceConfig-v1610
OPTIONAL -- Need N
]]
}

| | |
|---|---|
| PUCCH-FormatConfig ::= | SEQUENCE { |

| | |
|---|---|
| interslotFrequencyHopping | ENUMERATED {enabled} |
| OPTIONAL, -- Need R | |
| additionalDMRS | ENUMERATED {true} |
| OPTIONAL, -- Need R | |
| maxCodeRate | PUCCH-MaxCodeRate |
| OPTIONAL, -- Need R | |
| nrofSlots | ENUMERATED {n2,n4,n8} |
| OPTIONAL, -- Need S | |
| pi2BPSK | ENUMERATED {enabled} |
| OPTIONAL, -- Need R | |
| simultaneousHARQ-ACK-CSI | ENUMERATED {true} |
| OPTIONAL -- Need R | |
| } | |

| | |
|---|---|
| PUCCH-MaxCodeRate ::= | ENUMERATED {zeroDot08, zeroDot15, zeroDot25, |
| zeroDot35, zeroDot45, zeroDot60, zeroDot80} | |
| -- A set with one or more PUCCH resources | |
| PUCCH-ResourceSet ::= | SEQUENCE { |

| | |
|---|---|
| pucch-ResourceSetId | PUCCH-ResourceSetId, |
| resourceList | SEQUENCE (SIZE (1..maxNrofPUCCH-ResourcesPerSet)) |
| OF PUCCH-ResourceId, | |
| maxPayloadSize | INTEGER (4..256) |
| OPTIONAL -- Need R | |
| } | |

| | |
|---|---|
| PUCCH-ResourceSetId ::= | INTEGER (0..maxNrofPUCCH-ResourceSets-1) |
| PUCCH-Resource ::= | SEQUENCE { |

| | |
|---|---|
| pucch-ResourceId | PUCCH-ResourceId, |
| startingPRB | PRB-Id, |
| intraSlotFrequencyHopping | ENUMERATED { enabled } |
| OPTIONAL, -- Need R | |
| secondHopPRB | PRB-Id |
| OPTIONAL, -- Need R | |
| format | CHOICE { |
| format0 | PUCCH-format0, |
| format1 | PUCCH-format1, |
| format2 | PUCCH-format2, |
| format3 | PUCCH-format3, |
| format4 | PUCCH-format4 |
| } | |
| } | |

| | |
|---|---|
| PUCCH-ResourceExt-r16 ::= | SEQUENCE { |

| | |
|---|---|
| interlaceAllocation-r16 | SEQUENCE { |
| rb-SetIndex | INTEGER (0..4), |
| interlace0 | CHOICE { |
| scs15 | INTEGER (0..9), |
| scs30 | INTEGER (0..4) |
| } | |
| { | |
| OPTIONAL, --Need R | |
| formatExt-v1610 | CHOICE { |
| interlacel-v1610 | INTEGER (0..9), |
| occ-v1610 | SEQUENCE { |
| occ-Length-v1610 | ENUMERATED {n2,n4} |
| OPTIONAL, -- Need M | |
| occ-Index-v1610 | ENUMERATED {n0,n1,n2,n3} |
| OPTIONAL -- Need M | |
| } | |
| } | |
| OPTIONAL, -- Need R | |
| . . . | |
| } | |

| | |
|---|---|
| PUCCH-ResourceId ::= | INTEGER (0..maxNrofPUCCH-Resources-1) |

| | |
|---|---|
| PUCCH-format0 ::= | SEQUENCE { |
| initialCyclicShift | INTEGER(0..11), |
| nrofSymbols | INTEGER (1..2), |
| startingSymbolIndex | INTEGER(0..13) |
| } | |
| PUCCH-format1 ::= | SEQUENCE { |
| initialCyclicShcft | INTEGER(0..11), |
| nrofSymbols | INTEGER (4..14), |
| startingSymbolIndex | INTEGER(0..10), |
| timeDomainOCC | INTEGER(0..6) |
| } | |
| PUCCH-format2 ::= | SEQUENCE { |
| nrofPRBs | INTEGER (1..16), |
| nrofSymbols | INTEGER (1..2), |
| startingSymbolIndex | INTEGER(0..13) |
| } | |
| PUCCH-format3 ::= | SEQUENCE { |
| nrofPRBs | INTEGER (1..16), |
| nrofSymbols | INTEGER (4..14), |
| startingSymbolIndex | INTEGER(0..10) |
| } | |
| PUCCH-format4 ::= | SEQUENCE { |
| nrofSymbols | INTEGER (4..14), |
| occ-Length | ENUMERATED {n2,n4}, |
| occ-Index | ENUMERATED {n0,n1,n2,n3}, |
| startingSymbolIndex | INTEGER(0..10) |
| } | |

| | |
|---|---|
| PUCCH-ResourceGroup-r16 ::= | SEQUENCE { |

| | |
|---|---|
| pucch-ResourceGroupId-r16 | PUCCH-ResourceGroupId-r16, |
| resourcePerGroupLEst-r16 | SEQUENCE (SIZE (1..maxNrofPUCCH- |

ResourcesPerGroup-r16)) OF PUCCH-ResourceId
}

| | |
|---|---|
| PUCCH-ResourceGroupId-r16 ::= | INTEGER (0..maxNrofPUCCH-ResourceGroups-1-r16) |
| DL-DataToUL-ACK-r16 ::= | SEQUENCE (SIZE (1..8)) OF INTEGER (−1..15) |
| DL-DataToUL-ACK-ForDCI-Format1-2-r16 ::= | SEQUENCE (SIZE (1..8)) OF INTEGER (0..15) |

UL-AccessConfigListForDCI-Format1-1-r16 ::= SEQUENCE (SIZE (1..16)) OF INTEGER (0..15)
-- TAG-PUCCH-CONFIG-STOP
-- ASN1STOP

PUCCH-SpatialRelationInfo

The IE PUCCH-SpatialRelationInfo is used to configure the spatial setting for PUCCH transmission and the parameters for PUCCH power control, as specified in the 3GPP TS 38.213. More details of PUCCH-SpatialRelationInfo IE are introduced in the following.

-- ASN1START
-- TAG-PUCCH-SPATIALRELATIONINFO-START

| | |
|---|---|
| PUCCH-SpatialRelationInfo ::= | SEQUENCE { |
| pucch-SpatialRelationInfoId | PUCCH-SpatialRelationInfoId, |
| servingCellId | ServCellIndex |
| OPTIONAL, -- Need S | |
| referenceSignal | CHOICE { |
| ssb-Index | SSB-Index, |
| csi-RS-Index | NZP-CSI-RS-ResourceId, |
| srs | PUCCH-SRS |
| }, | |
| pucch-PathlossReferenceRS-Id | PUCCH-PathlossReferenceRS-Id, |
| p0-PUCCH-Id | P0-PUCCH-Id, |
| closedLoopIndex | ENUMERATED { i0, i1 } |
| } | |
| PUCCH-SpatialRelationInfoExt-r16 ::= | SEQUENCE { |
| pucch-SpatialRelationInfoId-v1610 | PUCCH-SpatialRelationInfoId-v1610 |
| OPTIONAL, -- Cond | SetupOnly |
| pucch-PathlossReferenceRS-Id-v1610 | PUCCH-PathlossReferenceRS-Id-v1610 |
| OPTIONAL, --Need R | |
| . . . | |
| } | |
| PUCCH-SRS ::= SEQUENCE { | |
| resource | SRS-ResourceId, |
| uplinkBWP | BWP-Id |
| } | |
| -- TAG-PUCCH-SPATIALRELATIONINFO-STOP | |
| -- ASN1STOP | |

SRS-Config

The IE SRS-Config is used to configure sounding reference signal transmissions or to configure sounding reference signal measurements for Cross Link Interference (CLI). The configuration defines a list of SRS-Resources and a list of SRS-ResourceSets. Each resource set defines a set of SRS-Resources. The network triggers the transmission of the set of SRS-Resources using a configured aperiodicSRS-ResourceTrigger (L1 DCI).

TCI-State

The IE TCI-State associates one or two DL reference signals with a corresponding quasi-colocation (QCL) type. More details of TCI-State IE are introduced in the following.

-- ASN1START
-- TAG-TCI-STATE-START

| | |
|---|---|
| TCI-State ::= | SEQUENCE { |
| tci-StateId | TCI-StateId, |
| qcl-Type1 | QCL-Info, |
| qcl-Type2 | QCL-Info |
| OPTIONAL, -- Need R | |
| . . . | |
| } | |
| QCL-Info ::= | SEQUENCE { |
| cell | ServCellIndex |
| OPTIONAL, -- Need R | |
| bwp-Id | BWP-Id |
| OPTIONAL, -- Cond CSI-RS-Indicated | |
| referenceSignal | CHOICE { |
| csi-rs | NZP-CSI-RS-ResourceId, |
| ssb | SSB-Index |
| }, | |
| qcl-Type | ENUMERATED {typeA, typeB, typeC, typeD}, |
| . . . | |
| } | |
| -- TAG-TCI-STATE-STOP | |
| -- ASN1STOP | |

DL Control Information

A DCI transports downlink control information for one or more cells with one RNTI.

The following coding steps can be identified:
Information element multiplexing;
CRC attachment;
Channel coding; and
Rate matching.

DCI Formats

The DCI formats are defined in Table 3.

TABLE 3

| DCI | |
|---|---|
| format | Usage |
| 0_0 | Scheduling of PUSCH in one cell |
| 0_1 | Scheduling of one or multiple PUSCH in one cell, or |
| | indicating downlink feedback information for |
| | configured grant PUSCH (CG-DFI) |
| 0_2 | Scheduling of PUSCH in one cell |
| 1_0 | Scheduling of PDSCH in one cell |
| 1_1 | Scheduling of PDSCH in one cell, and/or triggering |
| | one shot HARQ-ACK codebook feedback |
| 1_2 | Scheduling of PDSCH in one cell |
| | Notifying a group of UEs of the slot format, available |
| 2_0 | RB sets, COT duration and search space set group |
| | switching |
| 2_1 | Notifying a group of UEs of the PRB(s) and OFDM |
| | symbol(s) where UE may assume no transmission is |
| | intended for the UE |
| 2_2 | Transmission of TPC commands for PUCCH and |
| | PUSCH |
| 2_3 | Transmission of a group of TPC commands for SRS |
| | transmissions by one or more UEs |
| 2_4 | Notifying a group of UEs of the PRB(s) and OFDM |
| | symbol(s) where UE cancels the corresponding UL |
| | transmission from the UE |
| 2_5 | Notifying the availability of soft resources as defined |
| | in the 3GPP TS 38.473 |
| 2_6 | Notifying the power saving information outside DRX |
| | Active Time for one or more UEs |
| 3_0 | Scheduling of NR sidelink in one cell |
| 3_1 | Scheduling of LTE sidelink in one cell |

The fields defined in the DCI formats below are mapped to the information bits a₀ to a_{A-1} as follows.

Each field is mapped in the order in which it appears in the description, including the zero-padding bit(s), if any, with the first field mapped to the lowest order information bit a₀ and each successive field mapped to higher order information bits. The most significant bit of each field is mapped to the lowest order information bit for that field (e.g., the most significant bit of the first field is mapped to a₀).

If the number of information bits in a DCI format is less than 12 bits, zeros shall be appended to the DCI format until the payload size equals 12.

The size of each DCI format is determined by the configuration of the corresponding active bandwidth part of the scheduled cell and shall be adjusted if necessary.

Link Recovery Procedures

A UE can be provided, for each BWP of a serving cell, a set q̅₀̅ of periodic CSI-RS resource configuration indexes byfailureDetectionResources and a set q̅₁̅ of periodic CSI-RS resource configuration indexes and/or SS/PBCH block indexes by candidateBeamRSList or candidateBeamRSListExt-r16 or candidateBeamRSSCellList-r16 for radio link quality measurements on the BWP of the serving cell. If the UE is not provided q̅₀̅ by failureDetectionResources or beamFailureDetectionResourceList for a BWP of the serving cell, the UE determines the set q̅₀̅ to include periodic CSI-RS resource configuration indexes with same values as the RS indexes in the RS sets indicated by TCI-State for respective CORESETs that the UE uses for monitoring PDCCH and, if there are two RS indexes in a TCI state, the set q̅₀̅ includes RS indexes with QCL-TypeD configuration for the corresponding TCI states. The UE expects the set q̅₀̅ to include up to two RS indexes. The UE expects single port RS in the set q̅₀̅. The UE expects single-port or two-port CSI-RS with frequency density equal to 1 or 3 REs per RB in the set q̅₁̅.

The thresholds Q_{out,LR} and Q_{in,LR} correspond to the default value of rlmInSyncOutOfSyncThreshold, as described in the 3GPP TS 38.133 for Qₒᵤₜ, and to the value provided by rsrp-ThresholdSSB or rsrp-ThresholdBFR-r16, respectively.

The physical layer in the UE assesses the radio link quality according to the set q̅₀̅ of resource configurations against the threshold Q_{out,LR}. For the set q̅₀̅, the UE assesses the radio link quality only according to periodic CSI-RS resource configurations, or SS/PBCH blocks on the PCell or the PSCell, that are quasi co-located, as described in the 3GPP TS 38.214, with the DM-RS of PDCCH receptions monitored by the UE. The UE applies the Q_{in,LR} threshold to the L1-RSRP measurement obtained from a SS/PBCH block. The UE applies the Q_{in,LR} threshold to the L1-RSRP measurement obtained for a CSI-RS resource after scaling a respective CSI-RS reception power with a value provided by powerControlOffsetSS.

In non-DRX mode operation, the physical layer in the UE provides an indication to higher layers when the radio link quality for all corresponding resource configurations in the set q̅₀̅ that the UE uses to assess the radio link quality is worse than the threshold Q_{out,LR}. The physical layer informs the higher layers when the radio link quality is worse than the threshold Q_{out,LR} with a periodicity determined by the maximum between the shortest periodicity among the periodic CSI-RS configurations, and/or SS/PBCH blocks on the PCell or the PSCell, in the set q̅₀̅ that the UE uses to assess the radio link quality and 2 msec. In DRX mode operation, the physical layer provides an indication to higher layers when the radio link quality is worse than the threshold Q_{out,LR} with a periodicity determined as described in the 3GPP TS 38.133.

For the PCell or the PSCell, upon request from higher layers, the UE provides to higher layers the periodic CSI-RS configuration indexes and/or SS/PBCH block indexes from the set q̅₁̅ and the corresponding L1-RSRP measurements that are larger than or equal to the Q_{in,LR} threshold.

For the SCell, upon request from higher layers, the UE indicates to higher layers whether there is at least one periodic CSI-RS configuration index and/or SS/PBCH block index from the set q̅₁̅ with corresponding L1-RSRP measurements that are larger than or equal to the Q_{in,LR} threshold, and provides the periodic CSI-RS configuration indexes and/or SS/PBCH block indexes from the set q̅₁̅ and the corresponding L1-RSRP measurements that are larger than or equal to the Q_{in,LR} threshold, if any.

For the PCell or the PSCell, a UE can be provided a CORESET through a link to a search space set provided by recoverySearchSpaceId, for monitoring PDCCH in the CORESET. If the UE is provided recoverySearchSpaceId, the UE does not expect to be provided another search space set for monitoring PDCCH in the CORESET associated with the search space set provided by recoverySearchSpaceId.

For the PCell or the PSCell, the UE can be provided, by PRACH-ResourceDedicatedBFR, a configuration for PRACH transmission. For PRACH transmission in slot n and according to antenna port quasi co-location parameters associated with periodic CSI-RS resource configuration or with SS/PBCH block associated with index q_{new} provided by higher layers (see the 3GPP TS 38.321), the UE monitors PDCCH in a search space set provided by recoverySearchSpaceId for detection of a DCI format with CRC scrambled by C-RNTI or MCS-C-RNTI starting from slot n+4 within a window configured by BeamFailureRecoveryConfig. For PDCCH monitoring in a search space set provided by recoverySearchSpaceId and for corresponding PDSCH reception, the UE assumes the same antenna port quasi-collocation parameters as the ones associated with index q_{new} until the UE receives by higher layers an activation for a TCI state or any of the parameters tci-StatesPDCCH-ToAddList and/or tci-StatesPDCCH-ToReleaseList. After the UE detects a DCI format with CRC scrambled by C-RNTI or MCS-C-RNTI in the search space set provided by recoverySearchSpaceId, the UE continues to monitor PDCCH candidates in the search space set provided by recoverySearchSpaceId until the UE receives a MAC CE activation command for a TCI state or tci-StatesPDCCH-ToAddList and/or tci-StatesPDCCH-ToReleaseList.

For the PCell or the PSCell, after 28 symbols from a last symbol of a first PDCCH reception in a search space set provided by recoverySearchSpaceId for which the UE detects a DCI format with CRC scrambled by C-RNTI or MCS-C-RNTI and until the UE receives an activation command for PUCCH-SpatialRelationInfo (see the 3GPP TS 38.321) or is provided PUCCH-SpatialRelationInfo for PUCCH resource(s), the UE transmits a PUCCH on a same cell as the PRACH transmission using
a same spatial filter as for the last PRACH transmission
a power determined with qᵤ=0, q_{d}=q_{new}, and l=0.

For the PCell or the PSCell, after 28 symbols from a last symbol of a first PDCCH reception in a search space set provided by recoverySearchSpaceId where a UE detects a DCI format with CRC scrambled by C-RNTI or MCS-C-RNTI, the UE assumes same antenna port quasi-collocation parameters as the ones associated with index q_{new}, for PDCCH monitoring in a CORESET with index 0.

A UE can be provided, by schedulingRequestID-BFR-SCell-r16, a configuration for PUCCH transmission with a link recovery request (LRR). The UE can transmit in a first PUSCH MAC CE providing index(es) for at least corresponding SCell(s) with radio link quality worse than Q_{out,LR}, indication(s) of presence of q_{new} for corresponding SCell(s), and index(es) q_{new} for a periodic CSI-RS configuration or for a SS/PBCH block provided by higher layers, as described in the 3GPP TS 38.321, if any, for corresponding SCell(s). After 28 symbols from a last symbol of a PDCCH reception with a DCI format scheduling a PUSCH transmission with a same HARQ process number as for the transmission of the first PUSCH and having a toggled NDI field value, the UE
monitors PDCCH in all CORESETs on the SCell(s) indicated by the MAC CE using the same antenna port quasi co-location parameters as the ones associated with the corresponding index(es) q_{new}, if any
transmits PUCCH on a PUCCH-SCell using a same spatial domain filter as the one corresponding to q_{new} for periodic CSI-RS or SS/PBCH block reception, and using a power determined with qᵤ=0, q_{d}=q_{new}, and l=0, if
the UE is provided PUCCH-SpatialRelationInfo for the PUCCH,
a PUCCH with the LRR was either not transmitted or was transmitted on the PCell or the PSCell, and
the PUCCH-SCell is included in the SCell(s) indicated by the MAC-CE

where the SCS configuration for the 28 symbols is the smallest of the SCS configurations of the active DL BWP for the PDCCH reception and of the active DL BWP(s) of the at least one SCell.

UE Procedure for Determining PDCCH Assignment

For each DL BWP configured to a UE in a serving cell, the UE can be provided by higher layer signalling with
P≤3 CORESETs if CORESETPoolIndex is not provided, or if a value of CORESETPoolIndex is same for all CORESETs if CORESETPoolIndex is provided
P≤5 CORESETs if CORESETPoolIndex is not provided for a first CORESET, or is provided and has a value 0 for a first CORESET, and is provided and has a value 1 for a second CORESET

For each CORESET, the UE is provided the following by ControlResourceSet:
a CORESET index p, by controlResourceSetId, where
0≤p<12 if CORESETPoolIndex is not provided, or if a value of CORESETPoolIndex is same for all CORESETs if CORESETPoolIndex is provided;
0≤p<16 if CORESETPoolIndex is not provided for a first CORESET, or is provided and has a value 0 for a first CORESET, and is provided and has a value 1 for a second CORESET;
a DM-RS scrambling sequence initialization value by pdcch-DMRS-ScramblingID;
a precoder granularity for a number of REGs in the frequency domain where the UE can assume use of a same DM-RS precoder by precoderGranularity;
a number of consecutive symbols provided by duration;
a set of resource blocks provided by frequencyDomainResources;
CCE-to-REG mapping parameters provided by cce-REG-MappingType;
an antenna port quasi co-location, from a set of antenna port quasi co-locations provided by TCI-State, indicating quasi co-location information of the DM-RS antenna port for PDCCH reception in a respective CORESET;
if the UE is provided by simultaneousTCI-UpdateList-r16 or simultaneousTCI-UpdateListSecond-r16 up to two lists of cells for simultaneous TCI state activation, the UE applies the antenna port quasi co-location provided by TCI-States with same activated tci-StateID value to CORESETs with index p in all configured DL BWPs of all configured cells in a list determined from a serving cell index provided by a MAC CE command.
an indication for a presence or absence of a transmission configuration indication (TCI) field for a DCI format, other than DCI format 10, that schedules PDSCH receptions or indicates SPS PDSCH release and is transmitted by a PDCCH in CORESET p, by tci-PresentInDCI or tci-PresentInDCI-ForDCIFormat1_2.

Antenna Ports Quasi Co-Location

The UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-co-location relationship between one or two downlink reference signals and the DM-RS ports of the PDSCH, the DM-RS port of PDCCH or the CSI-RS port(s) of a CSI-RS resource. The quasi-co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi-co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives an activation command, as described in the 3GPP TS 38.321, used to map up to 8 TCI states to the codepoints of the DCI field ‘Transmission Configuration Indication’ in one CC/DL BWP or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs.

When a UE supports two TCI states in a codepoint of the DCI field ‘Transmission Configuration Indication’ the UE may receive an activation command, as described in the 3GPP TS 38.321, the activation command is used to map up to 8 combinations of one or two TCI states to the codepoints of the DCI field ‘Transmission Configuration Indication’. The UE is not expected to receive more than 8 TCI states in the activation command.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot n+3Nₛₗₒₜ^{subrame,μ} where m is the SCS configuration for the PUCCH. If tci-PresentInDCI is set to “enabled” or tci-PresentInDCI-ForFormat1_2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to ‘QCL-TypeA’, and when applicable, also with respect to ‘QCL-TypeD’.

If a UE is configured with the higher layer parameter tci-PresentInDCI that is set as ‘enabled’ for the CORESET scheduling the PDSCH, the UE assumes that the TCI field is present in the DCI format 1_1 of the PDCCH transmitted on the CORESET. If a UE is configured with the higher layer parameter tci-PresentInDCI-ForFormat1_2 for the CORESET scheduling the PDSCH, the UE assumes that the TCI field with a DCI field size indicated by tci-PresentInDCI-ForFormat1_2 is present in the DCI format 1_2 of the PDCCH transmitted on the CORESET. If the PDSCH is scheduled by a DCI format not having the TCI field present, and the time offset between the reception of the DL DCI and the corresponding PDSCH is equal to or greater than a threshold timeDurationForQCL if applicable, where the threshold is based on reported UE capability (see the 3GPP TS 38.306), for determining PDSCH antenna port quasi co-location, the ULE assumes that the TCI state or the QCL assumption for the PDSCH is identical to the TCI state or QCL assumption whichever is applied for the CORESET used for the PDCCH transmission.

If the PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability (see the 3GPP TS 38.306). When the UE is configured with a single slot PDSCH, the indicated TCI state should be based on the activated TCI states in the slot with the scheduled PDSCH. When the UE is configured with a multi-slot PDSCH, the indicated TCI state should be based on the activated TCI states in the first slot with the scheduled PDSCH, and UE shall expect the activated TCI states are the same across the slots with the scheduled PDSCH. When the UE is configured with CORESET associated with a search space set for cross-carrier scheduling and the UE is not configured with enableDefaultBeamForCSS, the UE expects tci-PresentInDCI is set as ‘enabled’ or tci-PresentInDCI-ForFormat1_2 is configured for the CORESET, and if one or more of the TCI states configured for the serving cell scheduled by the search space set contains ‘QCL-TypeD’, the UE expects the time offset between the reception of the detected PDCCH in the search space set and the corresponding PDSCH is larger than or equal to the threshold timeDurationForQCL.

Independent of the configuration of tci-PresentInDCI and tci-PresentInDCI-ForFormat1_2 in RRC connected mode, if the offset between the reception of the DL DCI and the corresponding PDSCH is less than the threshold timeDurationForQCL, the UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the ‘QCL-TypeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers). If none of configured TCI states for the serving cell of scheduled PDSCH contains ‘QCL-TypeD’, the UE shall obtain the other QCL assumptions from the indicated TCI states for its scheduled PDSCH irrespective of the time offset between the reception of the DL DCI and the corresponding PDSCH. If a UE is configured with enableDefaultTCIStatePerCoresetPoolIndex and the UE is configured by higher layer parameter PDCCH-Config that contains two different values of CORESETPoolIndex in ControlResourceSet, for both cases, when tci-PresentInDCI is set to ‘enabled’ and tci-PresentInDCI is not configured in RRC connected mode, if the offset between the reception of the DL DCI and the corresponding PDSCH is less than the threshold timeDurationForQCL, the UE may assume that the DM-RS ports of PDSCH associated with a value of CORESETPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of CORESETPoolIndex as the PDCCH scheduling that PDSCH, in the latest slot in which one or more CORESETs associated with the same value of CORESETPoolIndex as the PDCCH scheduling that PDSCH within the active BWP of the serving cell are monitored by the UE. When a UE is configured with enableTwoDefaultTCIStates, if the offset between the reception of the DL DCI and the corresponding PDSCH or the first PDSCH transmission occasion is less than the threshold timeDurationForQCL and at least one configured TCI states for the serving cell of scheduled PDSCH contains the ‘QCL-TypeD’, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme-r16 set to ‘TDMSchemeA’ or is configured with higher layer parameter repetitionNumber-r16, the mapping of the TCI states to PDSCH transmission occasions is determined by replacing the indicated TCI states with the TCI states corresponding to the lowest codepoint among the TCI codepoints containing two different TCI states.

If the PDCCH carrying the scheduling DCI is received on one component carrier, and the PDSCH scheduled by that DCI is on another component carrier and the UE is configured with enableDefaultBeamForCCS:
The timeDurationForQCL is determined based on the subcarrier spacing of the scheduled PDSCH. If μ_{PDCCH}<—_{PDSCH} an additional timing delay

$$d \frac{{2}^{μ} PDSCH}{{2}^{μ} PDCCH}$$

is added to the timeDurationForQCL, where d is defined in the 3GPP TS 38.214, otherwise d is zero;
For both the cases, when the offset between the reception of the DL DCI and the corresponding PDSCH is less than the threshold timeDurationForQCL, and when the DL DCI does not have the TCI field present, the UE obtains its QCL assumption for the scheduled PDSCH from the activated TCI state with the lowest ID applicable to PDSCH in the active BWP of the scheduled cell.

For a periodic CSI-RS resource in an NZP-CSI-RS-ResourceSet configured with higher layer parameter trs-Info, the UE shall expect that a TCI-State indicates one of the following quasi co-location type(s):
‘QCL-TypeC’ with an SS/PBCH block and, when applicable, ‘QCL-TypeD’ with the same SS/PBCH block, or
‘QCL-TypeC’ with an SS/PBCH block and, when applicable, ‘QCL-TypeD’ with a CSI-RS resource in an NZP-CSI-RS-ResourceSet configured with higher layer parameter repetition, or

For an aperiodic CSI-RS resource in an NZP-CSI-RS-ResourceSet configured with higher layer parameter trs-Info, the UE shall expect that a TCI-State indicates ‘QCL-TypeA’ with a periodic CSI-RS resource in an NZP-CSI-RS-ResourceSet configured with higher layer parameter trs-Info and, when applicable, ‘QCL-TypeD’ with the same periodic CSI-RS resource.

For a CSI-RS resource in an NZP-CSI-RS-ResourceSet configured without higher layer parameter trs-Info and without the higher layer parameter repetition, the UE shall expect that a TCI-State indicates one of the following quasi co-location type(s):
‘QCL-TypeA’ with a CSI-RS resource in a NZP-CSI-RS-ResourceSet configured with higher layer parameter trs-Info and, when applicable, ‘QCL-TypeD’ with the same CSI-RS resource, or
‘QCL-TypeA’ with a CSI-RS resource in a NZP-CSI-RS-ResourceSet configured with higher layer parameter trs-Info and, when applicable, ‘QCL-TypeD’ with an SS/PBCH block, or
‘QCL-TypeA’ with a CSI-RS resource in a NZP-CSI-RS-ResourceSet configured with higher layer parameter trs-Info and, when applicable, ‘QCL-TypeD’ with a CSI-RS resource in a NZP-CSI-RS-ResourceSet configured with higher layer parameter repetition, or
‘QCL-TypeB’ with a CSI-RS resource in a NZP-CSI-RS-ResourceSet configured with higher layer parameter trs-Info when ‘QCL-TypeD’ is not applicable.

For a CSI-RS resource in an NZP-CSI-RS-ResourceSet configured with higher layer parameter repetition, the UE shall expect that a TCI-State indicates one of the following quasi co-location type(s):
‘QCL-TypeA’ with a CSI-RS resource in a NZP-CSI-RS-ResourceSet configured with higher layer parameter trs-Info and, when applicable, ‘QCL-TypeD’ with the same CSI-RS resource, or
‘QCL-TypeA’ with a CSI-RS resource in a NZP-CSI-RS-ResourceSet configured with higher layer parameter trs-Info and, when applicable, ‘QCL-TypeD’ with a CSI-RS resource in a NZP-CSI-RS-ResourceSet configured with higher layer parameter repetition, or
‘QCL-TypeC’ with an SS/PBCH block and, when applicable, ‘QCL-TypeD’ with the same SS/PBCH block.

For the DM-RS of PDCCH, the UE shall expect that a TCI-State indicates one of the following quasi co-location type(s):
‘QCL-TypeA’ with a CSI-RS resource in a NZP-CSI-RS-ResourceSet configured with higher layer parameter trs-Info and, when applicable, ‘QCL-TypeD’ with the same CSI-RS resource, or
‘QCL-TypeA’ with a CSI-RS resource in a NZP-CSI-RS-ResourceSet configured with higher layer parameter trs-Info and, when applicable, ‘QCL-TypeD’ with a CSI-RS resource in an NZP-CSI-RS-ResourceSet configured with higher layer parameter repetition, or
‘QCL-TypeA’ with a CSI-RS resource in a NZP-CSI-RS-ResourceSet configured without higher layer parameter trs-Info and without higher layer parameter repetition and, when applicable, ‘QCL-TypeD’ with the same CSI-RS resource.

For the DM-RS of PDSCH, the UE shall expect that a TCI-State indicates one of the following quasi co-location type(s):
‘QCL-TypeA’ with a CSI-RS resource in a NZP-CSI-RS-ResourceSet configured with higher layer parameter trs-Info and, when applicable, ‘QCL-TypeD’ with the same CSI-RS resource, or
‘QCL-TypeA’ with a CSI-RS resource in a NZP-CSI-RS-ResourceSet configured with higher layer parameter trs-Info and, when applicable, ‘QCL-TypeD’ with a CSI-RS resource in an NZP-CSI-RS-ResourceSet configured with higher layer parameter repetition, or
QCL-TypeA’ with a CSI-RS resource in a NZP-CSI-RS-ResourceSet configured without higher layer parameter trs-Info and without higher layer parameter repetition and, when applicable, ‘QCL-TypeD’ with the same CSI-RS resource.

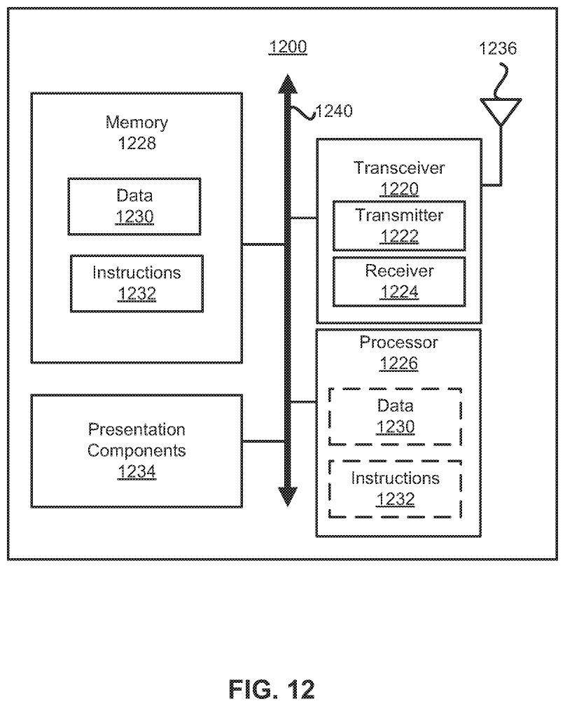

FIG. 12 is a block diagram illustrating a node 1200 for wireless communication, according to an implementation of the present disclosure.

As illustrated in FIG. 12, the node 1200 may include a transceiver 1220, a processor 1226, a memory 1228, one or more presentation components 1234, and at least one antenna 1236. The node 1200 may also include a Radio Frequency (RF) spectrum band module, a BS communications module, a network communications module, a system communications management module, input/output (I/O) ports, I/O components, and a power supply (not illustrated in FIG. 12).

Each of these components may be in communication with each other, directly or indirectly, over one or more buses 1240. The node 1200 may be a UE or a BS that performs various disclosed functions illustrated in FIG. 1 and examples in this disclosure.

The transceiver 1220 may include a transmitter 1222 (with transmitting circuitry) and a receiver 1224 (with receiving circuitry) and may be configured to transmit and/or receive time and/or frequency resource partitioning information. The transceiver 1220 may be configured to transmit in different types of subframes and slots including, but not limited to, usable, non-usable and flexibly usable subframes and slot formats. The transceiver 1220 may be configured to receive data and control channels.

The node 1200 may include a variety of computer-readable media. Computer-readable media may be any media that can be accessed by the node 1200 and include both volatile (and non-volatile) media and removable (and non-removable) media. Computer-readable media may include computer storage media and communication media. Computer storage media may include both volatile (and/or non-volatile), as well as removable (and/or non-removable), media implemented according to any method or technology for storage of information such as computer-readable media.

Computer storage media may include RAM, ROM, EPROM, EEPROM, flash memory (or other memory technology), CD-ROM, Digital Versatile Disk (DVD) (or other optical disk storage), magnetic cassettes, magnetic tape, magnetic disk storage (or other magnetic storage devices), etc. Computer storage media do not include a propagated data signal.

Communication media may typically embody computer-readable instructions, data structures, program modules, or other data in a modulated data signal such as a carrier wave or other transport mechanisms and include any information delivery media. The term “modulated data signal” may mean a signal that has one or more of its characteristics set or changed in such a manner as to encode information in the signal. Communication media may include wired media such as a wired network or direct-wired connection, and wireless media such as acoustic, RF, infrared, and other wireless media. Combinations of any of the disclosed media should be included within the scope of computer-readable media.

The memory 1228 may include computer-storage media in the form of volatile and/or non-volatile memory. The memory 1228 may be removable, non-removable, or a combination thereof. For example, the memory 1228 may include solid-state memory, hard drives, optical-disc drives, etc. As illustrated in FIG. 12, the memory 1228 may store computer-readable and/or computer-executable instructions 1232 (e.g., software codes) that are configured to, when executed, cause the processor 1226 (e.g., processing circuitry) to perform various disclosed functions. Alternatively, the instructions 1232 may not be directly executable by the processor 1226 but may be configured to cause the node 1200 (e.g., when compiled and executed) to perform various disclosed functions.

The processor 1226 may include an intelligent hardware device, a central processing unit (CPU), a microcontroller, an ASIC, etc. The processor 1226 may include memory. The processor 1226 may process the data 1230 and the instructions 1232 received from the memory 1228, and information received through the transceiver 1220, the baseband communications module, and/or the network communications module. The processor 1226 may also process information to be sent to the transceiver 1220 for transmission via the antenna 1236, and/or to the network communications module for transmission to a CN.

One or more presentation components 1234 may present data to a person or other devices. Presentation components 1234 may include a display device, a speaker, a printing component, a vibrating component, etc.

From the present disclosure, it is evident that various techniques can be utilized for implementing the disclosed concepts without departing from the scope of those concepts. Moreover, while the concepts have been disclosed with specific reference to specific implementations, a person of ordinary skill in the art would recognize that changes can be made in form and detail without departing from the scope of those concepts. As such, the present disclosure is to be considered in all respects as illustrative and not restrictive. It should also be understood that the present disclosure is not limited to the specific disclosed implementations, but that many rearrangements, modifications, and substitutions are possible without departing from the scope of the present disclosure.

What is claimed is:

1. A method of updating spatial parameters for a user equipment (UE), the method comprising:
receiving, from a network, at least one configuration for one or more serving cells;
receiving, from the network, a beam failure recovery (BFR) configuration applicable for a serving cell of the one or more serving cells;
detecting a beam failure in the serving cell of the one or more serving cells;
transmitting, to the network, a request for a BFR in the serving cell, the request indicating a downlink (DL) reference signal (RS) or being associated with the DL RS;
receiving, from the network, a response corresponding to the transmitted request;
receiving, after receiving the response, one or more control resource sets (CORESETs) in the serving cell via a spatial receiving (RX) parameter derived from the DL RS; and
transmitting, after receiving the response, one or more physical uplink control channel (PUCCH) resources in the serving cell via a spatial transmitting (TX) parameter derived from the DL RS.

2. The method of claim 1, further comprising at least one of:
receiving a physical downlink control channel (PDCCH) in the serving cell via the spatial RX parameter;
receiving a physical downlink shared channel (PDSCH) in the serving cell via the spatial RX parameter; and
transmitting a physical uplink shared channel (PUSCH) in the serving cell via the spatial TX parameter.

3. The method of claim 2, wherein at least one of the PDCCH, the one or more CORESETs and the PDSCH in the serving cell are associated with a value of an index same as that of the DL RS, or that of the response.

4. The method of claim 3, wherein the index includes at least one of a CORESETPoolIndex, an index related to a transmission or reception point (TRP), a Physical Identity (PCI), and an index related to a panel for receiving the DL RS.

5. The method of claim 2, wherein the PUSCH in the serving cell is associated with a value of an index same as that of the DL RS, or that of the response.

6. The method of claim 1, wherein receiving, after receiving the response, the one or more CORESETs in the serving cell comprises receiving all CORESETs excluding CORESET 0 in the serving cell via the spatial RX parameter.

7. The method of claim 1, wherein the serving cell is one of a Primary Cell (PCell), a Primary Secondary Cell (PSCell) and a Secondary Cell (SCell).

8. The method of claim 1, further comprising:
receiving, from the network, an indication to the UE to apply the spatial RX parameter for a DL reception in the serving cell.

9. The method of claim 1, further comprising:
receiving, from the network, an indication to the UE to apply the spatial TX parameter for an UL transmission in the serving cell.

10. A user equipment (UE) for updating spatial parameters, the UE comprising:
a processor, for executing a computer-executable program; and
a memory, coupled to the processor, for storing the computer-executable program, wherein the computer-executable program instructs the processor to:
receive, from a network, at least one configuration for one or more serving cells;
receive, from the network, a beam failure recovery (BFR) configuration applicable for a serving cell of the one or more serving cells;
detect a beam failure in the serving cell of the one or more serving cells;
transmit, to the network, a request for a BFR in the serving cell, the request indicating a downlink (DL) reference signal (RS) or being associated with the DL RS;
receive, from the network, a response corresponding to the transmitted request;
receive, after receiving the response, one or more control resource sets (CORESETs) in the serving cell via a spatial receiving (RX) parameter derived from the DL RS; and
transmit, after receiving the response, one or more physical uplink control channel (PUCCH) resources in the serving cell via a spatial transmitting (TX) parameter derived from the DL RS.

11. The UE of claim 10, wherein the computer-executable program further instructs the processor to at least one of:
receive a physical downlink control channel (PDCCH) in the serving cell via the spatial RX parameter;
receive a physical downlink shared channel (PDSCH) in the serving cell via the spatial RX parameter; or
transmit a physical uplink shared channel (PUSCH) in the serving cell via the spatial TX parameter.

12. The UE of claim 11, wherein at least one of the PDCCH, the one or more CORESETs and the PDSCH in the serving cell are associated with a value of an index same as that of the DL RS, or that of the response.

13. The UE of claim 12, wherein the index includes at least one of a CORESETPoolIndex, an index related to a transmission or reception point (TRP), a Physical Identity (PCI), and an index related to a panel for receiving the DL RS.

14. The UE of claim 11, wherein the PUSCH in the serving cell is associated with a value of an index same as that of the DL RS, or that of the response.

15. The UE of claim 10, wherein the computer-executable program further instructs the processor to receive all CORESETs excluding CORESET 0 in the serving cell via the spatial RX parameter, after receiving the response.

16. The UE of claim 10, wherein the serving cell is one of a Primary Cell (PCell), a Primary Secondary Cell (PSCell) and a Secondary Cell (SCell).

17. The UE of claim 10, wherein the computer-executable program further instructs the processor to:
receive, from the network, an indication to the UE to apply the spatial RX parameter for a DL reception in the serving cell.

18. The UE of claim 10, wherein the computer-executable program further instructs the processor to:
receive, from the network, an indication to the UE to apply the spatial TX parameter for an UL transmission in the serving cell.
